(19) United States
(12) Patent Application Publication
(10) Pub. No.: US 2016/0355535 A1
(43) Pub. Date: Dec. 8, 2016

(54) FATTY ACID DERIVATIVES OF LIGNIN AND USES THEREOF

(71) Applicant: North Carolina State University, Raleigh, NC (US)

(72) Inventors: Richard A. Venditti, Raleigh, NC (US); Siddhesh N. Pawar, Raleigh, NC (US); Ali Ayoub, Raleigh, NC (US); Hou-Min Chang, Raleigh, NC (US); Hasan Jameel, Cary, NC (US)

(21) Appl. No.: 15/145,962

(22) Filed: May 4, 2016

Related U.S. Application Data
(60) Provisional application No. 62/156,599, filed on May 4, 2015.

(51) Int. Cl. C07G 1/00

(52) U.S. Cl. CPC C07G 1/00

(57) ABSTRACT

The present disclosure provides fatty acid derivatives of lignin with improved properties such as workability and other physical properties. These derivatives have the ability to form polymer blends with improved properties such as carbon fiber production and compatibilizers.

### CROSS REFERENCE TO RELATED APPLICATIONS

This application claims the benefit of U.S. Provisional Appn. 62/156,599 filed May 4, 2015; Venditti et al. having attorney docket number 127/88 PROV which is hereby incorporated by reference in its entirety.

### STATEMENT REGARDING FEDERALLY SPONSORED RESEARCH OR DEVELOPMENT

This invention was made with government support under Grant No. 1503/2011-0952 awarded by the U.S. Department of Agriculture. The U.S. Government has certain rights in the invention.

### 1. FIELD

The present disclosure provides fatty acid derivatives of lignin with improved properties such as workability and other physical properties. These derivatives have the ability to form polymer blends with improved properties.

### 2. BACKGROUND

### 2.1. Introduction

Lignin is an important component of biomass, both in terms of its mass contribution and functionality. Lignin's structure as part of the wood composite is a topic of intense scientific debate. For example, while it is widely reported in the literature as a cross-linked network polymer, a recent report indicated to lignin being a linear oligomer.¹ The pulp and paper industry is estimated to produce more than 50 million tons of lignin annually, most of which is burnt off to meet the energy demands of the pulp mills.² Lignin when used as a fuel yields a value equivalent of $0.18/kg. However, if converted to high-value products, the value equivalent can potentially be raised up to $1.08/kg.³ Therefore, there is enormous interest in transforming lignin to attain properties competitive with commercial high volume polymers such as polyethylene (PE), polypropylene (PP), polystyrene (PS) and polyvinyl chloride (PVC). Factors influencing the physicochemical properties of lignin are the type and specie of woody or non-woody biomass, the technical process used for pulping, and the method used to separate lignin from black liquor. Depending on these factors, technical lignins may contain varying amounts of methoxyl, phenolic hydroxyl, primary and secondary aliphatic hydroxyl, carbonyl and carboxyl groups. In this study we shall focus on utilization of the hydroxyl groups for lignin modification.

Several ways of modifying lignin via hydroxyl group reactions were previously reported. Most recently, Argyropoulos et al. described methylation of lignin using dimethyl sulfate or methyl iodide to create a lignin based thermoplastic material.⁴⁻⁵ Glasser et al. previously reported the hydroxyalkylation of lignin by reaction with alkylene oxides to create engineering plastics.⁶⁻⁷ Hydroxypropyl lignin (HPL) derivatives were subsequently epoxidized and crosslinked networks formed using aromatic diamines as curing agents.⁸ Glasser at al. also described lignin based polyurethane films using HPL reaction with diisocyanates.⁹ To improve stretching, polyethylene glycol (PEG) and poly(butadiene glycol) extended polyurethanes were also reported.¹⁰⁻¹¹ In addition to polymeric modification of the hydroxyl groups, simple acetylation procedures involving acetic anhydride and pyridine are routinely performed in laboratories for lignin analysis.¹² More recently, a solventless system comprising of softwood kraft lignin and styrene monomer was subjected to γ-irradiation to prepare polystyrene grafted lignin derivatives via radical chemistry.¹³

While the lignin modification literature is vast, large scale commercialization of lignin based products has been stifled due the products being brittle and non-recyclable. A survey of the patent literature showed a recent patent publication in which acetylated lignin was reacted with tall oil fatty acids to obtain fatty acid esters of lignin, as acetic acid was distilled off during reaction.¹⁴ These derivatives have both acetyl groups and tall fatty acid ester groups and were reported to be more hydrophobic and possessed low melting points.

### 3. SUMMARY OF THE DISCLOSURE

This disclosure is directed to a fatty acid derivative of lignin consisting essentially of a lignin and a fatty acid. The fatty acid and the lignin may be present in a mole ratio ranging from about 0.1:1.0 to about 4.0:1.0; about 0.2:1.0 to about 2.0:1.0; about 0.3:1.0 to about 1.5:1.0; about 0.1:0.2 to about 0.4:0.5; about 0.2:0.3 to about 0.5:0.6; about 0.3:0.4 to about 0.6:0.7; about 0.4:0.5 to about 0.7:0.8; about 0.5:0.6 to about 0.8:0.9. The lignin and the fatty acid may be present in a ratio of about 1.0 lignin to about 0.1-0.6 fatty acid; about 1.0 lignin to about 0.2-0.5 fatty acid; about 1.0 lignin to about 0.2 to 0.4 fatty acid; or about 1.0 lignin to about 0.3 to 0.4 fatty acid.

The fatty acid derivative may soluble in a non-polar solvent, a polar aprotic solvent or a polar protic solvent.

The fatty acid may be an unsaturated fatty acid, a saturated fatty acid. The fatty acid derivative may be a C4-C30 ester such as C18 fatty acid ester, a linoleic acid ester, or an oleic acid ester. The fatty acid may be a fatty acid of phosphatidylethanolamine, a fatty acid of soybean lecithin, or an unsaturated fatty acid of egg lecithin.

The lignin may be a hardwood lignin, a softwood lignin, a non-wood plant material. The non-wood plant material may be an energy crop agricultural waste, a food crop agricultural waste, or a grass.

The disclosure also includes an article of manufacture which comprises a polymer blend comprising a thermoplastic polymer and a fatty acid derivative of lignin consisting essentially of a lignin and a fatty acid. The thermoplastic polymer may be a natural or synthetic polymer. The natural polymer may be a, a soy protein, silk protein, acetate cellulose or a starch. The synthetic polymer may be a petroleum pitch, polyacrylonitrile, polyethylene, polypropylene, polystyrene, polyvinyl chloride, polyamide, ABS or a mixture thereof. In the article of manufacture, the fatty acid derivative of lignin may comprise about 3% to about 97% of the polymer blend; about 5% to about 95% of the polymer blend; about 15% to about 85% of the polymer blend; about 30% to about 70% of the polymer blend.

The disclosure also provides a starting material for carbon fiber production which comprises a fatty acid derivative of lignin consisting essentially of a lignin and a fatty acid. The starting material may further comprise a thermoplastic polymer. The thermoplastic polymer may be a natural or synthetic polymer. The carbon fiber production may be for renewable carbon fiber production.

The disclosure also provides a method of improving the workability of a lignin which comprises esterifying the lignin with an activated fatty acid under suitable conditions so as to form a fatty acid derivative of lignin consisting essentially of the lignin and the fatty acid. The suitable conditions may be base-catalyzed esterification conditions. The activated fatty acid may be a fatty acid chloride or a fatty acid anhydride. The method may further comprise melting and cooling the fatty acid derivative of lignin so as to form an amorphous material. Alternatively, the method may further comprise irradiation of the fatty acid derivative of lignin to further improve its workability and its carbon yield on carbonization.

The disclosure also provides method of making a fatty acid derivative of lignin which consists essentially of: contacting a lignin with an unsaturated fatty acid under appropriate conditions of heat and/or pressure; and recovering the fatty acid derivative of lignin. The appropriate conditions may be heating the lignin and the unsaturated fatty acid to about 110° C. to about 145° C.; about 110° C. to about 120° C.; about 115° C. to about 125° C.; about 120° C. to about 130° C.; or about 130° C. to about 145° C. Alternatively, the appropriate conditions may be extruding the lignin and the unsaturated fatty acid.

The disclosure also provides a method of making a fatty acid derivative of lignin which comprises; dissolving a lignin in a suitable solvent; reacting the dissolved lignin with an activated fatty acid and a suitable catalyst; and recovering the fatty acid derivative of lignin. The suitable solvent may be an organic solvent or an ionic liquid.

The activated fatty acid may be an acid chloride of a fatty acid or the suitable catalyst may be pyridine.

The disclosure also provides a method of improving the workability of a thermoplastic polymer which comprises adding a fatty acid derivative of lignin to the thermoplastic polymer so as to form a compatible polymer blend. The thermoplastic polymer may be a natural or synthetic polymer.

In addition, the disclosure provides a method to determine the degree of substitution of a fatty acid derivative of lignin prepared from a fatty acid having an aliphatic portion and a lignin having methoxyl groups which comprises dissolving the fatty acid derivative of lignin in an appropriate solvent, measuring an area of nuclear magnetic resonance spectroscopy (NMR) peaks associated with the aliphatic region of the fatty acid and measuring an area of the methoxyl groups of the lignin, determining a ratio of the areas associated with the fatty acid and the methoxyl groups and thereby calculating a degree of substitution of the fatty acid derivative of lignin. The NMR peaks may be 1H-NMR peaks or 13C-NMR peaks.

### 4. BRIEF DESCRIPTION OF THE FIGURES

FIG. 1. 1H-NMR spectra of BCL and LS-97%

FIG. 2. FTIR spectra of BCL and LS-97%

FIG. 3. DSC thermograms of BCL compared to LS-90% and LS-97%

FIG. 4. XRD patterns of BCL, LS-90% Pre-melt and Post-melt

FIG. 5. Schematic representation (top) and images (bottom) of LS before and after melting

FIG. 6. SEM images of (a) BCL, (b) LS Pre-Melt and (c) LS Post-Melt

FIG. 7. Heat flow versus temperature for lignin 30% unsaturated fatty acid blends, with physical blending, hot pressing or extrusion.

FIG. 8. TGA plots of Stearic acid, BCL and LS

FIG. 9. Melting endotherms observed in the 1^{st} heating scans in DSC for LS samples reported in Table 1

FIG. 10. Melting endotherms observed in the 2^{nd} heating scans in DSC for LS samples reported in Table 1

FIG. 11. TGA curves for PA+LS-97% blends at different LS concentrations

FIG. 12. TGA curves for PA+LS-46% blends at different LS concentrations

FIG. 13. TGA curves for PA+BCL blends at different BCl concentrations

FIG. 14. DSC thermogram (2^{nd} scan) for PS

FIG. 15. DSC thermogram (2^{nd} scan) for PS blend film containing 5% concentration of LS-97%

FIG. 16. DSC thermogram (2^{nd} scan) for PS blend film containing 25% concentration of LS-97%

FIG. 17. DSC thermogram (2^{nd} scan) for PS blend film containing 50% concentration of LS-97%

FIG. 18. DSC thermogram (2^{nd} scan) for PS blend film containing 75% concentration of LS-97%

FIG. 19. DSC thermogram (2^{nd} scan) for PS blend film containing 100% concentration of LS-97%

FIG. 20. DSC thermogram (2^{nd} scan) for PS blend film containing 5% concentration of LS-46%

FIG. 21. DSC thermogram (2^{nd} scan) for PS blend film containing 25% concentration of LS-46%

FIG. 22. DSC thermogram (2^{nd} scan) for PS blend film containing 50% concentration of LS-46%

FIG. 23. DSC thermogram (2^{nd} scan) for PS blend film containing 75% concentration of LS-46%

FIG. 24. DSC thermogram (2^{nd} scan) for PS blend film containing 100% concentration of LS-46%

FIG. 25. DSC thermogram (2^{nd} scan) for PS blend film containing 5% concentration of BCL

FIG. 26. DSC thermogram (2^{nd} scan) for PS blend film containing 25% concentration of BCL

FIG. 27. DSC thermogram (2^{nd} scan) for PS blend film containing 50% concentration of BCL

FIG. 28. DSC thermogram (2^{nd} scan) for PS blend film containing 75% concentration of BCL

FIG. 29. DSC thermogram (2^{nd} scan) for PS blend film containing 100% concentration of BCL

### 5. DETAILED DESCRIPTION OF THE DISCLOSURE

Lignin is an abundant renewable polymer that is available is large quantities as byproduct of the paper and biorefinery industries. Lignin utilization for higher value applications is complicated by an inability to process it due to ensuing thermal crosslinking. A new method to attach fatty acids to lignin is reported which alters its thermal behavior. By attaching saturated C₁₈ fatty acids to OH groups, stable lignin stearates (LS) of controllable degrees of substitution (DS) were synthesized. A New NMR method to determine DS was established. The stearate chains formed ordered crystalline phases which upon heating caused the lignin derivatives to melt. The ability of LS to plasticize polystyrene (PS) is reported wherein integral blend films containing up to 25% by weight of LS were formed. Compared to pure PS, the T_{g} of the blended films could be lowered by 22° C. using LS.

In this study, we describe the synthesis of fatty acid esters of non-acetylated softwood kraft lignin using acid chlorides. Fatty acids are a byproduct of the papermaking operation, and depending on the type of fatty acid chain attached, interesting thermal and physical properties can be expected. A commercial fatty acid chloride was used in the study. Products with varying degrees of substitution (DS) were prepared. A new ¹H-NMR method for quantifying the number of fatty acid chains attached to the lignin molecule is described. Thermal analysis was performed using TGA and DSC. Finally, compatibility of the new derivatives with polystyrene (PS) and their ability to plasticize PS is reported.

### 5.1. Definitions

While the following terms are believed to be well understood by one of ordinary skill in the art, the following definitions are set forth to facilitate explanation of the presently disclosed subject matter.

Throughout the present specification, the terms “about” and/or “approximately” may be used in conjunction with numerical values and/or ranges. The term “about” is understood to mean those values near to a recited value. For example, “about 40 [units]” may mean within ±25% of 40 (e.g., from 30 to 50), within ±20%, ±15%, ±10%, ±9%, ±8%, ±7%, ±6%, ±5%, ±4%, ±3%, ±2%, ±1%, less than ±1%, or any other value or range of values therein or there below. Furthermore, the phrases “less than about [a value]” or “greater than about [a value]” should be understood in view of the definition of the term “about” provided herein. The terms “about” and “approximately” may be used interchangeably.

The term “fatty acid” refers to a carboxylic acid with an aliphatic tail which may be saturated or unsaturated. The term includes short chain fatty acids (2-5 carbon aliphatic tail), medium chain fatty acids (6-12 carbon aliphatic tail), long chain fatty acids (13-21 carbon aliphatic tail), very long chain fatty acids (22 or greater carbon aliphatic tail), fatty acid of phosphatidylethanolamine, a fatty acid of soybean lecithin, or an unsaturated fatty acid of egg lecithin. See exemplary common fatty acids in Table 6.

The term “lignin” refers to a plant-based amorphous polyphenolic material from the enzymatic dehydration of phenyl propanoid monomers including but not limited to coniferyl alcohol, p-coumaryl alcohol, sinapyl alcohol, and ferulic acid. For example, the lignin can be derived from both wood and non-wood plant sources (including but not limited to herbaceous sources). Non-limiting examples of herbaceous or wood lignin sources useful according to the invention include wood (e.g., hardwood and/or softwood), energy grasses (e.g., switchgrass, miscanthus, and reed canary grass), bamboo, bamboo pulp, bamboo sawdust, castor oil plant, cereal straw, corn, corn cobs, corn residues, cornhusks, grain processing by-products, rapeseed plant, sorghum, soybean plant, sugarcane bagasse, or tobacco. Still further, lignin sources may be “waste” materials, such as corn stover, energy crop agricultural wastes, food crop agricultural waste, rice straw, paper sludge, waste papers, municipal solid wastes, and refuse-derived materials. The lignin also may be from the paper making process, including various grades of paper and pulp, including recycled paper, which include various amounts of lignins, recycled pulp, bleached paper or pulp, semi-bleached paper or pulp, and unbleached paper or pulp.

The term “polymer” may be a natural, a semisynthetic polymer, or a synthetic polymer. Examples of such polymers include albumins, aliginic acids, carboxymethylcelluloses, sodium salt cross-linked, celluloses, cellulose acetates, cellulose acetate butyrates, cellulose acetate phthalates, cellulose acetate trimelliates, chitins, chitosans, collagens, dextrins, ethylcelluloses, gelatins, guargums, hydroxypropylmethyl celluloses (HPC), karana gums, methyl celluloses, poloxamers, polysaccharides, silk protein, sodium starch glycolates, starch thermally modifieds, tragacanth gums, or xanthangum polysaccharides.

Examples of synthetic polymers include cellophane (polyethylene-coated), monomethoxypolyethylene glycols (mPEG), nylons, polyacetals, polyacrylates, poly(alkylene oxides), polyamides, polyamines, polyanhydrides, polyargines, polybutylene oxides (PBO), polybutyolactones, polycaprolactones (PCL), polycarbonates, polycyanoacrylates, poly(dioxanones) (PDO), polyesters, polyethers, polyethylenes, poly(ethylene-propylene) copolymers, poly(ethylene glycols) (PEG), poly(ethylene imines), polyethylene oxides (PEO), polyglycolides (PGA), polyhydroxyacids, polylactides (PLA), polylysines, polymethacrylates (PMA), poly(methyl vinyl ethers) (PMV), poly(N-vinylpyrrolidinones) (NVP), polyornithines, poly(orthoesters) (POE), polyphosphazenes, polypropiolactones, polypropylenes, poly(propylene glycols) (PPG), polypropylene oxides (PPO), polypropylfumerates, polyserines, polystyrenes, polyureas, polyurethanes, polyvinyl alcohols (PVA), poly(vinyl chlorides) (PVC), poly (vinyl pyrrolidines), silicon rubbers, or blends thereof.

The polymer may be a homopolymer, a copolymer, a block copolymer with monomers from one or more the polymers above. If the polymer comprises asymmetric monomers, it may be regio-regular, isotactic or syndiotactic (alternating); or region-random, atactic. If the polymer comprises chiral monomers, the polymer may be stereo-regular or a racemic mixture, e.g., poly(D-, L-lactic acid). It may be a random copolymer, an alternating copolymer, a periodic copolymer, e.g., repeating units with a formula such as [AₙBₘ]. The polymer may be a linear polymer, a ring polymer, a branched polymer, e.g., a dendrimer. The polymer may or may not be cross-linked. The polymer may be a block copolymer comprising a hydrophilic block polymer and a hydrophobic block polymer.

The polymer may be comprise derivatives of individual monomers chemically modified with substituents, including without limitation, alkylation, e.g., (poly C₁-C₁₆ alkyl methacrylate), amidation, esterification, ether, or salt formation. The polymer may also be modified by specific covalent attachments the backbone (main chain modification) or ends of the polymer (end group modifications). Examples of such modifications include attaching PEG (PEGylation) or albumin.

In certain embodiments, the polymer may be a poly(dioxanone). The poly(dioxanone) may be poly(p-dioxanone), see U.S. Pat. Nos. 4,052,988; 4,643,191; 5,080,665; and 5,019,094, the contents of which are hereby incorporated by reference in their entirety. The polymer may be a copolymer of poly(alkylene oxide) and poly(p-dioxanone), such as a block copolymer of poly(ethylene glycol) (PEG) and poly(p-dioxanone) which may or may not include PLA, see U.S. Pat. No. 6,599,519, the content of which is hereby incorporated by reference in its entirety.

The polymer used in the particle is a polyester, a polyester-polycation copolymer, a polyester-polysugar copolymer, see U.S. Pat. No. 6,410,057, the content of which is hereby incorporated by reference in its entirety.

In some embodiments, the polymer may be a polyethylene oxide (POE). Examples of POE block copolymers include U.S. Pat. Nos. 5,612,052 and 5,702,717, the contents of which are hereby incorporated by reference in their entirety. In some embodiments, a polymeric matrix may be a polylactide (PLA), including poly(L-lactic acid), poly(D-lactic acid), poly(D-,L-lactic acid); a polyglycolide (PGA); poly(lactic-co-glycolic acid) (PLGA); poly (lactic-co-dioxanone) (PLDO) which may or may not include polyethylene glycol (PEG). See U.S. Pat. Nos. 4,862,168; 4,452,973; 4,716,203; 4,942,035; 5,384,333; 5,449,513; 5,476,909; 5,510,103; 5,543,158; 5,548,035; 5,683,723; 5,702,717; 6,616,941 (e.g., Table 1); U.S. Pat. No. 6,916,788 (e.g., Table 4, PLA-PEG, PLDO-PEG, PLGA-PEG), U.S. Pat. No. 7,217,770 (PEG-PLA); U.S. Pat. No. 7,311,901 (amphophilic copolymers); U.S. Pat. No. 7,550,157 (mPEG-PCL, mPEG-PLA, mPEG-PLDO, mPEG-PLGA, and micelles); U.S. Pat. Pub. No. 2010/0008998 (Table 2, PEG2000/4000/10,000-mPEG-PLA); PCT Pub. Nos. 2009/084801 (mPEG-PLA and mPEG-PLGA micelles), the contents of which are hereby incorporated by reference in their entirety. In some embodiments, a polymer comprise proteins, lipids, surfactants, carbohydrates, small molecules, and/or polynucleotides.

The fatty acid derivatives of lignin described herein may be soluble in “solvents” with differing polarities. The term “non-polar” solvent means a reagent with low polarity which may have a dielectric constant ranging from 1.84 to 9.1 and a dipole moment 0.00D to 1.60D. Non-limiting examples include 1,4-dioxane, benzene, chloroform, cyclohexane, cyclopentane, dichloromethane (DCM), diethyl ether, hexane, pentane, or toluene. The term “polar aprotic” solvent means a polar reagent without an acidic hydrogen which may have a dielectric constant ranging from 6.0 to 64 and a dipole moment 1.75D to 4.9D. Non-limiting examples include acetone, acetonitrile (MeCN), dimethyl sulfoxide (DMSO), dimethylformamide (DMF), ethyl acetate, nitromethane, propylene carbonate, or tetrahydrofuran (THF). The term “polar protic” solvent means a polar reagent with a free hydroxyl group, which may have a dielectric constant ranging from 55 to 80 and a dipole moment 1.4D to 1.85D. Non-limiting examples include acetic acid, ethanol, formic acid, isopropanol (IPA), methanol, n-butanol, n-propanol, or water.

Throughout the present specification, numerical ranges are provided for certain quantities. It is to be understood that these ranges comprise all subranges therein. Thus, the range “from 50 to 80” includes all possible ranges therein (e.g., 51-79, 52-78, 53-77, 54-76, 55-75, 60-70, etc.). Furthermore, all values within a given range may be an endpoint for the range encompassed thereby (e.g., the range 50-80 includes the ranges with endpoints such as 55-80, 50-75, etc.).

The term “a” or “an” refers to one or more of that entity.

As used herein, the verb “comprise” as is used in this description and in the claims and its conjugations are used in its non-limiting sense to mean that items following the word are included, but items not specifically mentioned are not excluded.

Throughout the specification the word “comprising,” or variations such as “comprises” or “comprising,” will be understood to imply the inclusion of a stated element, integer or step, or group of elements, integers or steps, but not the exclusion of any other element, integer or step, or group of elements, integers or steps. The present disclosure may suitably “comprise”, “consist of”, or “consist essentially of”, the steps, elements, and/or reagents described in the claims.

It is further noted that the claims may be drafted to exclude any optional element. As such, this statement is intended to serve as antecedent basis for use of such exclusive terminology as “solely”, “only” and the like in connection with the recitation of claim elements, or the use of a “negative” limitation.

Unless defined otherwise, all technical and scientific terms used herein have the same meanings as commonly understood by one of ordinary skill in the art to which this disclosure belongs. Preferred methods, devices, and materials are described, although any methods and materials similar or equivalent to those described herein can be used in the practice or testing of the present disclosure. All references cited herein are incorporated by reference in their entirety.

The following Examples further illustrate the disclosure and are not intended to limit the scope. In particular, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

### 6. EXAMPLES

### 6.1. Materials and Methods

Biochoice™ (BCL) Softwood Kraft Lignin was provided by Domtar. Chemical composition of BCL was as follows: lignin=98.2%, arabinan=0.2%, galactan=0.7%, glucan=0.1%, xylan=0.4%, and ash=0.73%, with pH=3.9. Molecular weight=5500 g mol. Elemental composition was as follows: Methoxyl content=13.8%; Carbon=64.4%; Hydrogen=6.24%; Oxygen=27.9%; Nitrogen=0.36%; Sulfur=1.36%. Molecular formula of C9 unit=C9H8.93O2.37(OCH3)0.814S0.079 with an average MW of 182.6 g/mol; Quantitative 13C-NMR analysis yielded the following groups per 100 aromatic rings: 5-5′ ether=31.8, β-1=1.2, β-5=4.0, primary aliphatic OH=26.6, secondary aliphatic OH=17.6, phenolic OH=49.4, total etherified=52.0, methoxyl=63.2, Cγ in β-O-4 without Cα=O=11.5, aliphatic COOR=8.7, conjugated COOR=4.3, and degree of condensation=71.4. Stearoyl chloride (St-Cl), pyridine (Pyr), 1,4-dioxane, methanol, reagent alcohol, hexane, acetone, chloroform, KBr, CDCl3, DMSO-d6 and polystyrene (PS) were obtained from Sigma-Aldrich (St. Louis, Mo., USA). All chemicals were used as purchased except 1,4-dioxane, which was distilled over NaOH and stored under N₂.

Synthesis of lignin stearate (LS): Lignin (2 g) was weighed into a 3-neck flask. 5 mL dioxane was added and stirred to dissolve at room temperature for roughly 2-3 hours under N₂. The required amounts of St-Cl and Pyr (calculated based on total OH groups available) were then added to the flask and stirred at 80° C. for roughly 18 hours. Following the reaction, the mixture was added dropwise to a suitable precipitating solvent. The crude solid was then filtered under vacuum and recovered. To further purify the crude product, it was washed in a Soxhlet extractor overnight using a suitable extraction solvent. Generally, the precipitation solvent was the same as extraction solvent. The choice of precipitation and extractions solvents depended on the amount of St-Cl added for reaction [Table 1]. After extraction, the solid was retrieved, dried in air first and then under vacuum at room temperature.

¹H-NMR. Analysis was performed using a Bruker 300 MHz NMR with manual lock and shim. Choice of the NMR solvent was dictated by the amount of stearate substitution. Products with higher DS dissolved in CDCl₃, while those with lower DS were soluble in DMSO-d₆. For acquisition, 6-10 mg solid was weighed and dissolved in 0.6 mL of solvent and added to a 5 mm NMR tube. Acquisition was performed at room temperature and 64 scans were obtained. Data analysis was performed using MestReNova LITE v. 5.2.5

FTIR. Analysis was performed using a Perkin Elmer Frontier instrument in transmission mode. Around 200 mg of KBr was weight along with 3-4 mg of lignin stearate and ground together in a mortar-pestle. The mixture was then pelletized using a Perkin Elmer 15 ton manual hydraulic press. Number of scans obtained for each measurement was 32.

Thermogravimetric analysis (TGA). Measurements were performed using TA Q500 instrument (TA, New Castle, Del.) instrument loaded with a platinum pan. Sample amounts ranged between 5-10 mg under N₂ atmosphere. Heating rate employed was 10° C./min from 40-600° C. Data analysis was performed using Universal Analysis 2000, build 4.5.0.5

Differential scanning calorimetry (DSC). Measurements were performed using TA Q100 instrument (TA, New Castle, Del.) equipped with a chiller. Sample amounts ranged between 5-10 mg and the analysis was carried out under N₂ atmosphere using aluminum hermetic pans with a hole punched to facilitate moisture removal. The experimental protocol used was as follows: (A) Heat to 105° C. at 10° C./min, and hold isothermally for 20 min to completely remove moisture. (B) Cool to 40° C. at 10 C/min. This completes heating cycle number 1. (C) Heat to 180° C. at 10° C./min. (D) Cool to 40° C. at 10 C/min. This completes heating cycle number 2. (E) Heat to 180° C. at 10° C./min (F) Cool to 40° C. at 10 C/min. This completes heating cycle number 3. A slightly modified protocol was used for PS blend films and is described as follows: (A) Heat to 180° C. at 10° C./min, and hold isothermally for 5 min. (B) Cool to 20° C. at 10 C/min. (C) Heat to 180° C. at 10° C./min. T_{g}'s were measured during the second heating scan. Data analysis was performed using Universal Analysis 2000, build 4.5.0.5

LS-PS blends. Mixtures of LS and PS were prepared with LS contents of 0, 5, 25, 50, 75 and 100%. A total of 200 mg of solid (LS+PS) was weighed for each mixture. The mixtures were then dissolved in 1 ml solvent which contained a 50-50 mixture of acetone+CHCl₃. The LS-PS mixtures were allowed to dissolve. For blank, 200 mg of solid (BCL+PS) was weighed for each mixture, and dissolved in 1 mL 1,4-dioxane. Thereafter, the solutions were placed in silicone molds, covered with aluminum foil and dried overnight at room temperature until most of the solvent had evaporated. The molds were then placed in a vacuum chamber at room temperature for complete drying.

X-ray diffraction (XRD). Measurements were performed using a PANalytical Empyrean X-Ray diffractometer with linear detector and non-ambient environment at 40 kV voltage and 25 mA. Scanned angle was set between 5-33°.

Scanning electron microscopy (SEM). Morphologies were examined using FEI XHR-Verios 460L microscope. Powdered samples were deposited on a carbon tape placed on a stage, with the excess being blown off using a jet of dry N₂ gas. A concentric backscatter detector was used to obtain high quality images.

### 6.2. Results and Discussion

Of the functional groups generally present in lignin, hydroxyl groups are abundant and easily accessible to reagents. While OH groups are not among the most reactive species, a good way to get reaction products with high conversions is by using reactive reagents. Esterification reactions are a common way to react OH groups. Typically encountered reagents to achieve these reactions can be carboxylic acids, and their acid chlorides and anhydrides. Of the three, carboxylic acids are least reactive. Acid chlorides and anhydrides can react rapidly with free hydroxyls to yield esters. Since the objective of this study was to synthesize fatty acid esters, we considered the use of both fatty acid chlorides and anhydrides as reagents. Commercial acid chlorides were significantly cheaper relative to anhydrides and were therefore selected. Additionally, we will limit this article to the synthesis and property evaluation of lignin esters synthesized from stearoyl chloride—a C₁₈ saturated fatty acid chloride.

The reaction procedure employed in the synthesis of lignin stearates first involved the dissolution of lignin in a suitable non-aqueous. Homogeneous dissolution is known to allow better accessibility to the reactive functional groups relative to heterogeneous mixtures.¹⁵ For this study, we were able to dissolve softwood kraft lignin in 1,4-dioxane at a concentration of 40% (w/v). Upon dissolution, the desired amount of the reagent St-Cl was added. Scheme 1 shows the reaction.

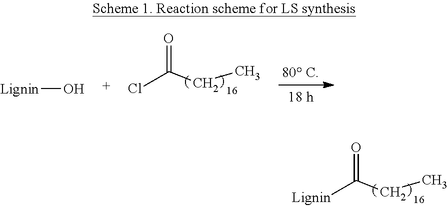

Molar calculations required an estimation of the number of OH groups available in lignin. ¹³C-NMR studies revealed that 93.6±3 OH groups were present per 100 aromatic rings. Additionally, the average molar mass of the C₉ residue for lignin was 182 g/mol. Based on this information, the molar equivalents of St-Cl relative to available OH groups were calculated and added to the reaction mixture. A reaction temperature of 80° C. was used to prevent thermal condensation reactions.

Reaction workup entailed choosing an appropriate solvent for precipitation and extraction. As expected, upon derivatization with stearate esters, lignin becomes more hydrophobic. The hydrophobicity is a direct function of the DS. This is evident from the solubility characteristics shown in Table 1. At higher DS values, lignin stearate becomes fully soluble in hydrophobic solvents such as hexane or chloroform, but insoluble in polar solvents such as DMSO. While at lower DS values, complete solubility in polar solvents such as DMSO was observed, LS was insoluble in hexane or chloroform. This change in the hydrophilicity-hydrophobicity balance of the lignin esters dictates the solvents used during workup.

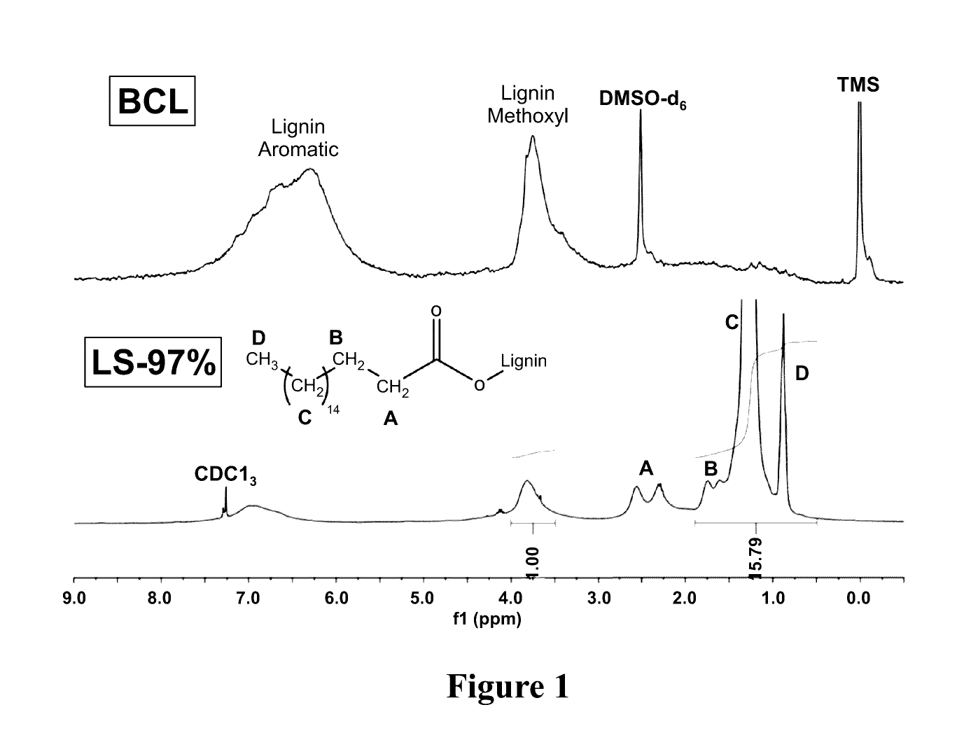

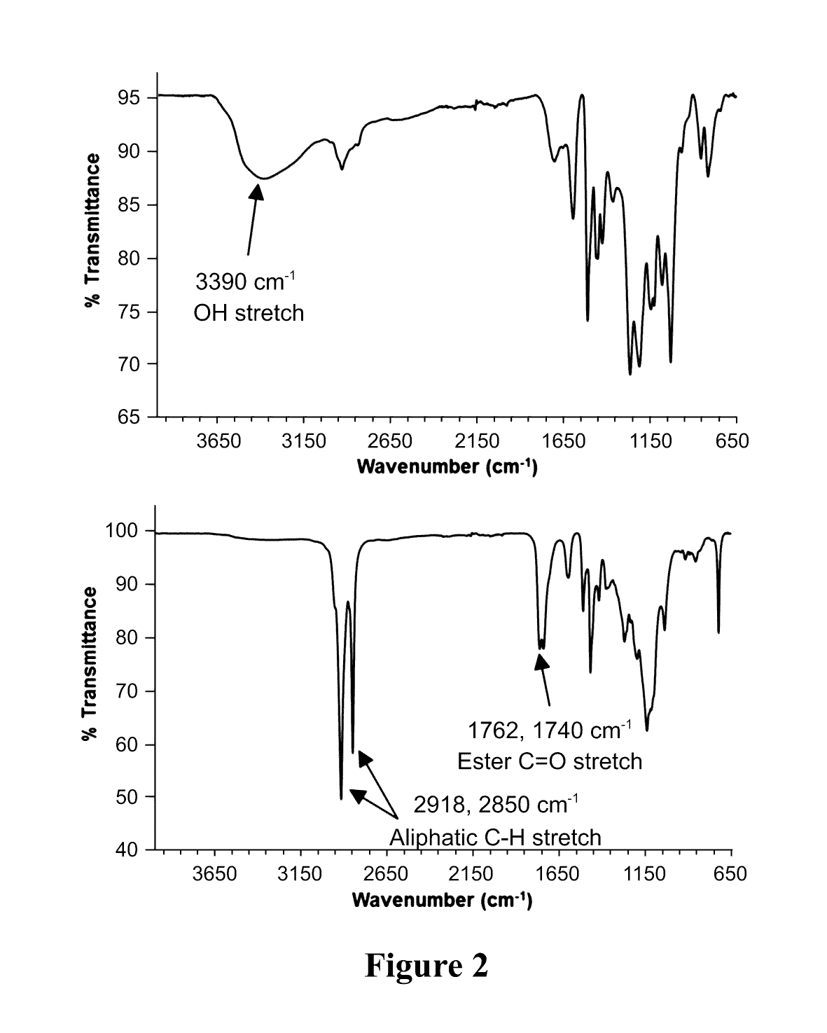

Structural characterization of products was performed using ¹H-NMR and FTIR. Lignin prior to fatty acid derivatization is soluble in DMSO-d₆. Similarly, lignin stearates with low DS values were dissolved in DMSO-d₆ for NMR analysis. Products with higher degrees of substitution dissolved in CDCl₃. FIG. 1 shows a comparison of the ¹H-NMR spectra of BCL and the corresponding lignin stearate formed upon derivatization. In the lignin spectrum, two broad peaks can be observed—the aromatic protons appear around 7.0 ppm while the methoxyl protons are observed around 3.5 ppm. Upon stearate derivatization, additional signals arising from the stearate protons appear in the region between 0.5-3.0 ppm. The FTIR spectra in FIG. 2 show a comparison of lignin and fully derivatized lignin stearate (LS-97% from Table 1). Non-derivatized lignin shows a broad OH stretching vibration around 3390 cm⁻¹. Upon derivatization, the OH stretching disappears, and two new sets of peaks appear—aliphatic C—H stretching from the stearate groups (2918, 2850 cm⁻¹) and ester C═O stretching vibration (1740, 1762 cm⁻¹). This evidence strongly supports the formation of stearate esters of lignin.

¹H-NMR is a powerful tool that can be used to measure the DS value of lignin esters. Because stearate proton signals are separated from lignin, they can be integrated relative to a standard. Known amounts of standards such as tetramethylsilane (TMS) or 2,3,4,5,6-pentafluorobenzaldehyde (PFB) may be added externally to the NMR tube. The stearate peaks can be integrated relative to the peaks arising from the standard. DS can then be measured in terms of the number of stearate groups per gram of LS sample. The precision of this method however depends on a number of factors such as accurate weighing of the standard, purity and stability of the standards, and use of an appropriate d₁ (relaxation delay) parameter during NMR acquisition. Furthermore, describing the DS as ‘number of stearate groups per gram of sample’ was not the best form of expressing the value. Since the OH group content of BCL was measured in terms of ‘number of OH groups per 100 aromatic rings’, it would be more fitting to describe DS as the ‘number of stearate groups per 100 aromatic rings’. To circumvent these problems, the methoxyl peaks of lignin were used as an internal standard to calculate DS by peak integration. Methoxyl groups are linked to the lignin aromatic rings via ether groups. Under the conditions used for reaction and work-up, the ether groups are expected to remain intact. The number of methoxyls per 100 aromatic rings was 63.2, as calculated using ¹³C-NMR. This number was thus expected to stay constant even as lignin was converted to lignin stearate. Therefore, by integrating the methoxyl region in the ¹H-NMR spectrum (3.5-4.5 ppm) relative to the stearate signals (0.5-3.0 ppm), DS was calculated as the number of stearate groups per 100 aromatic rings. Table 1 describes how the DS was controlled by varying the molar equivalents of St-Cl and pyridine in the reaction.

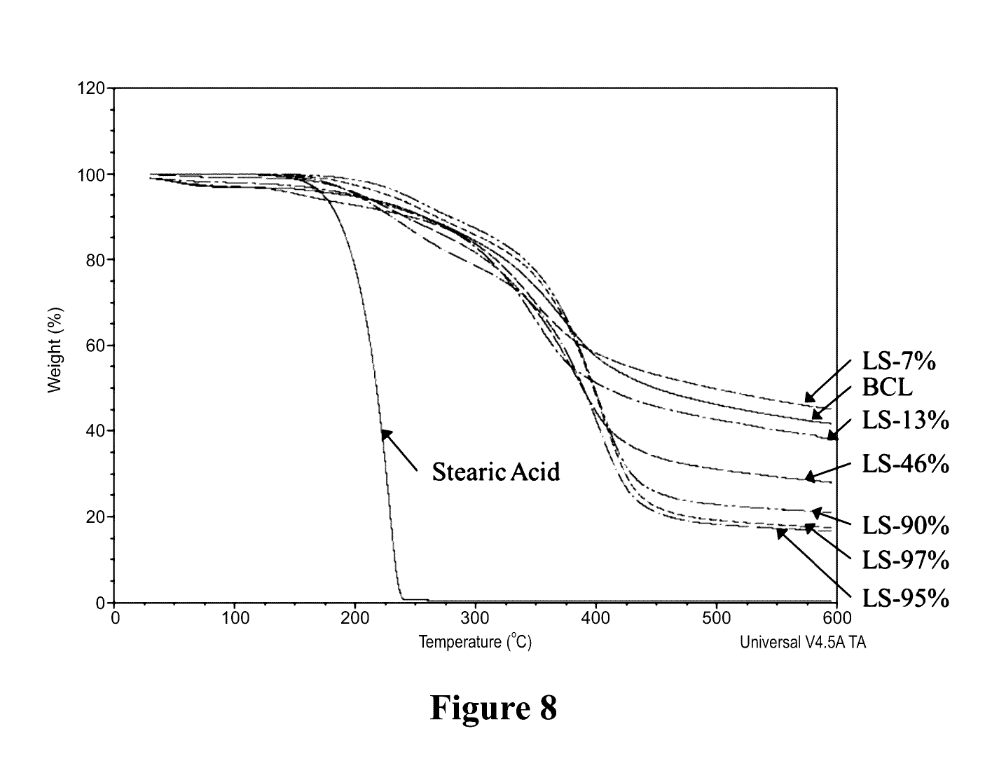

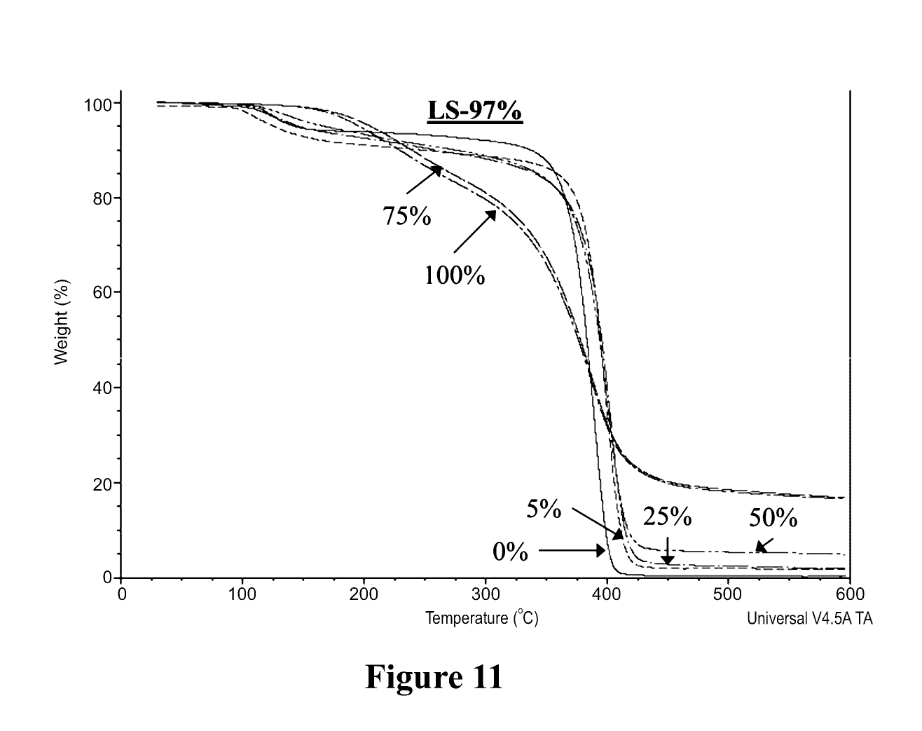

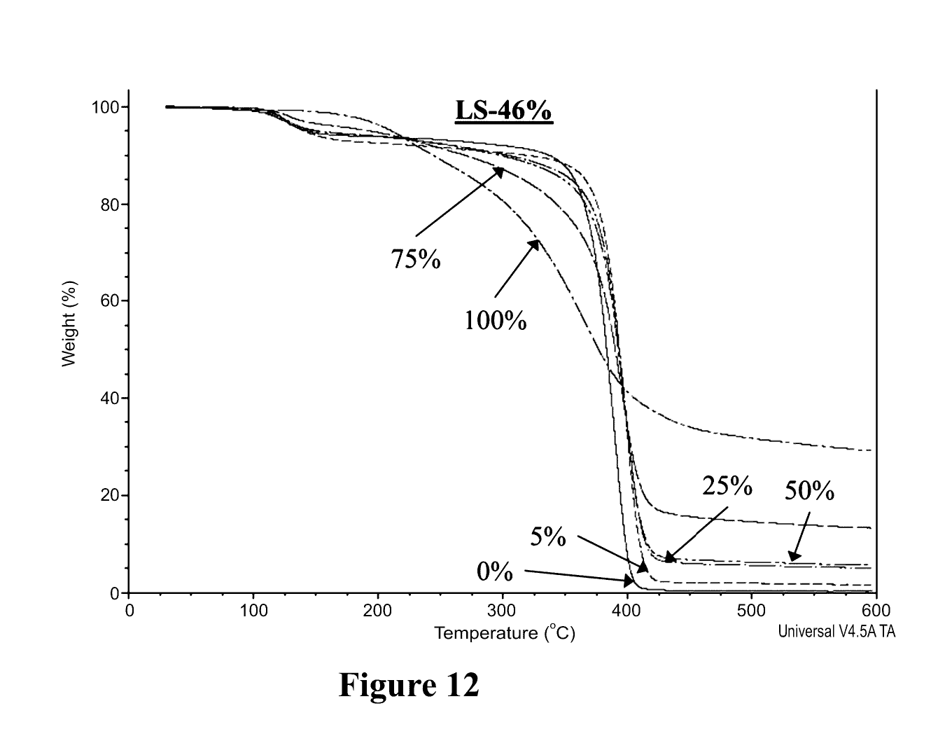

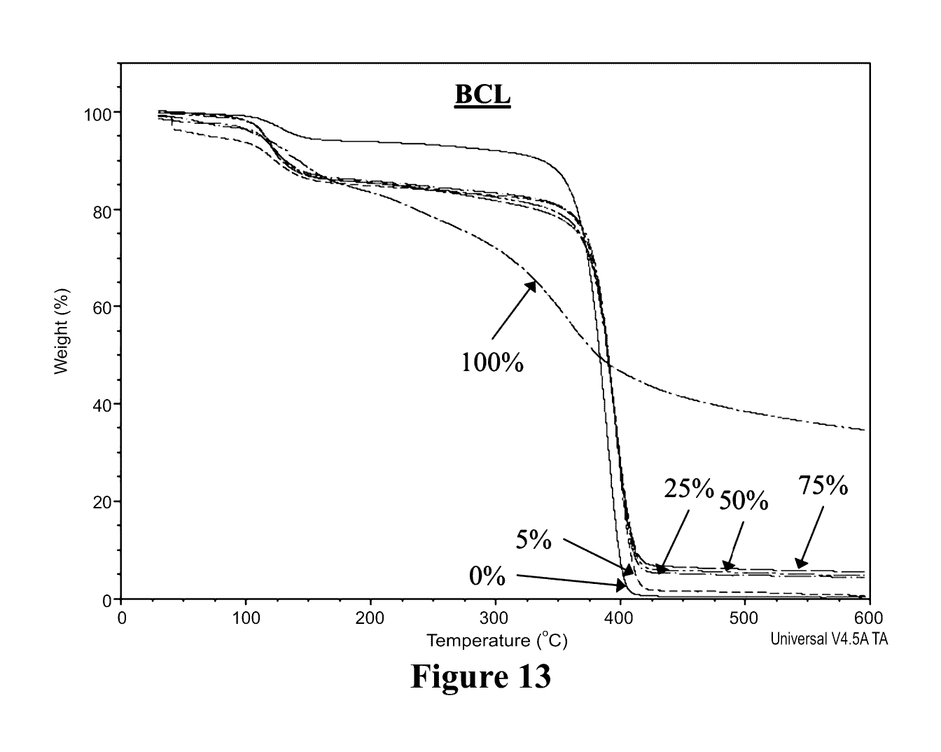

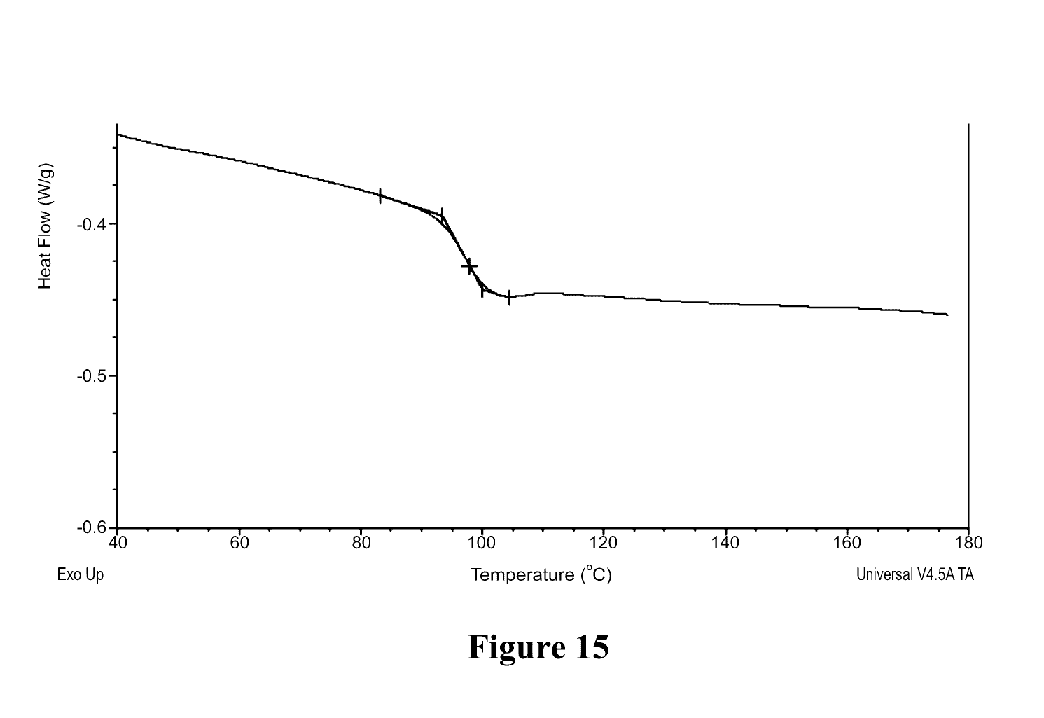

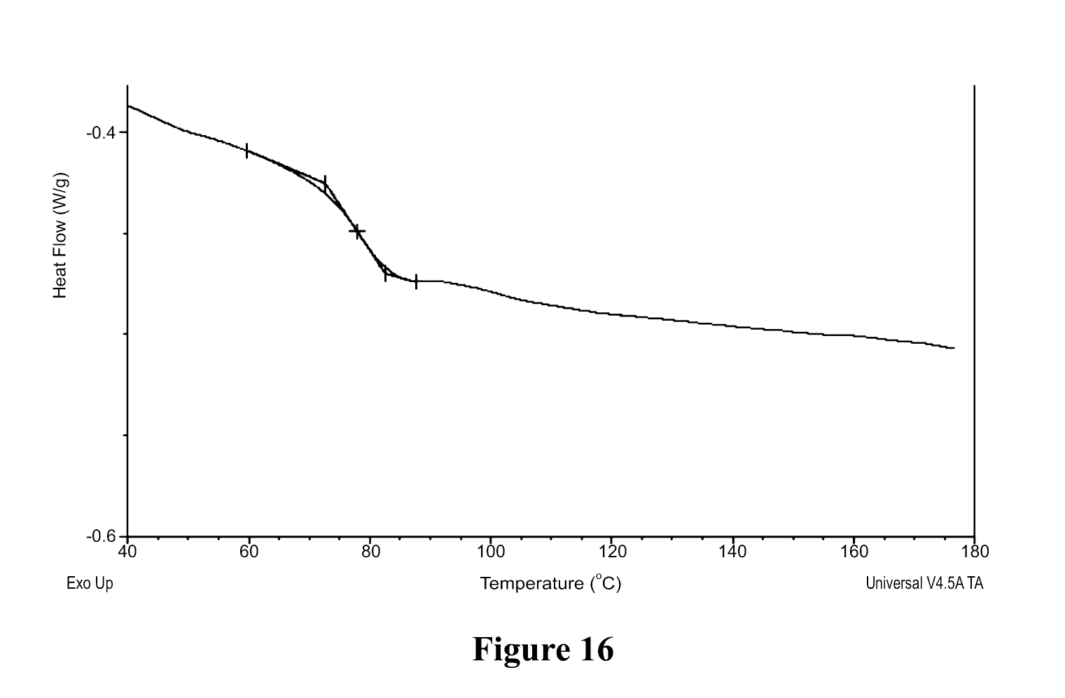

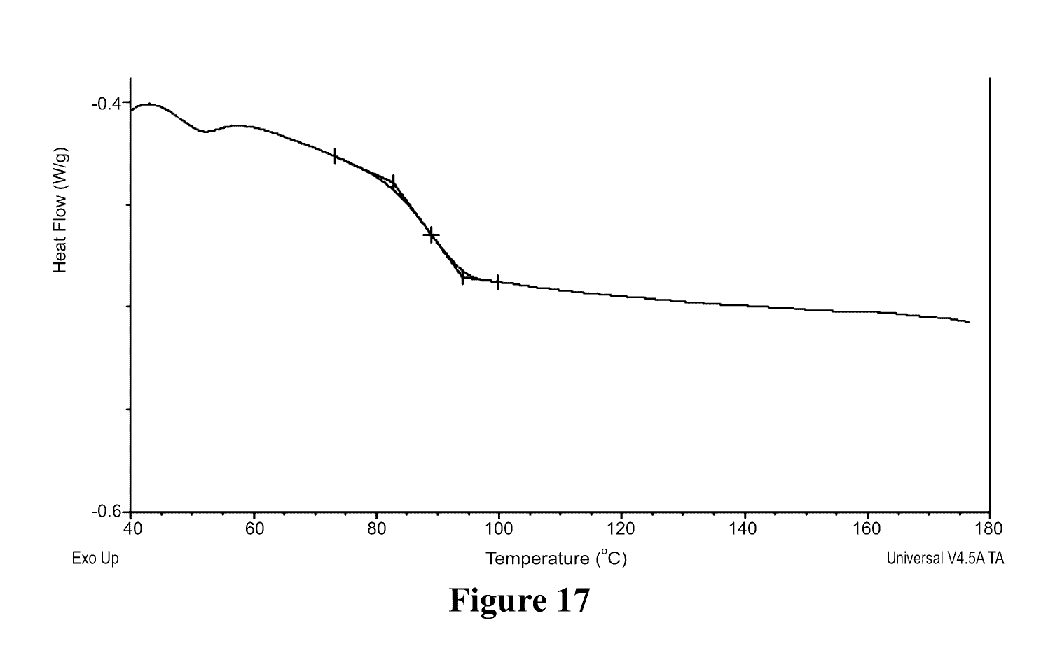

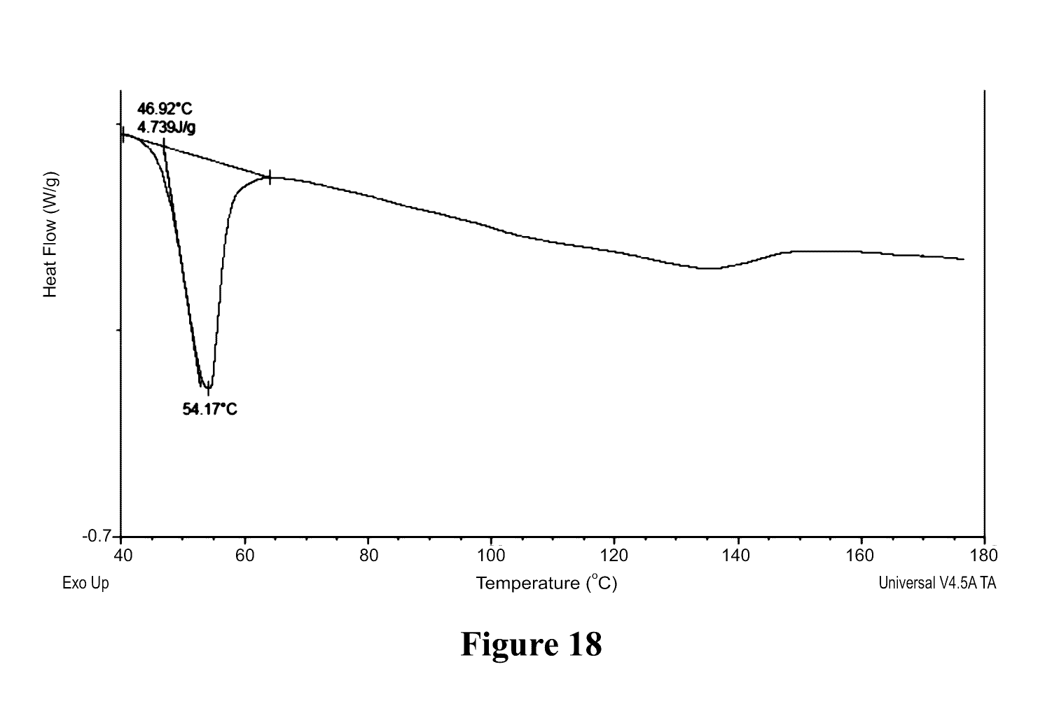

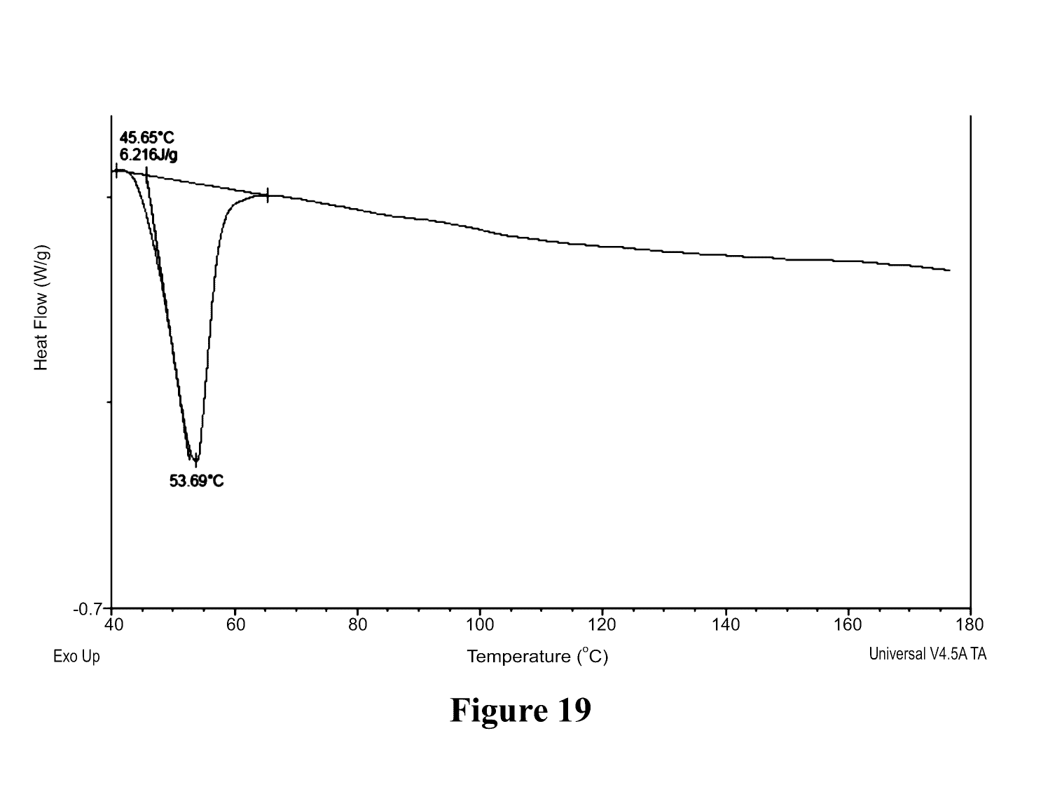

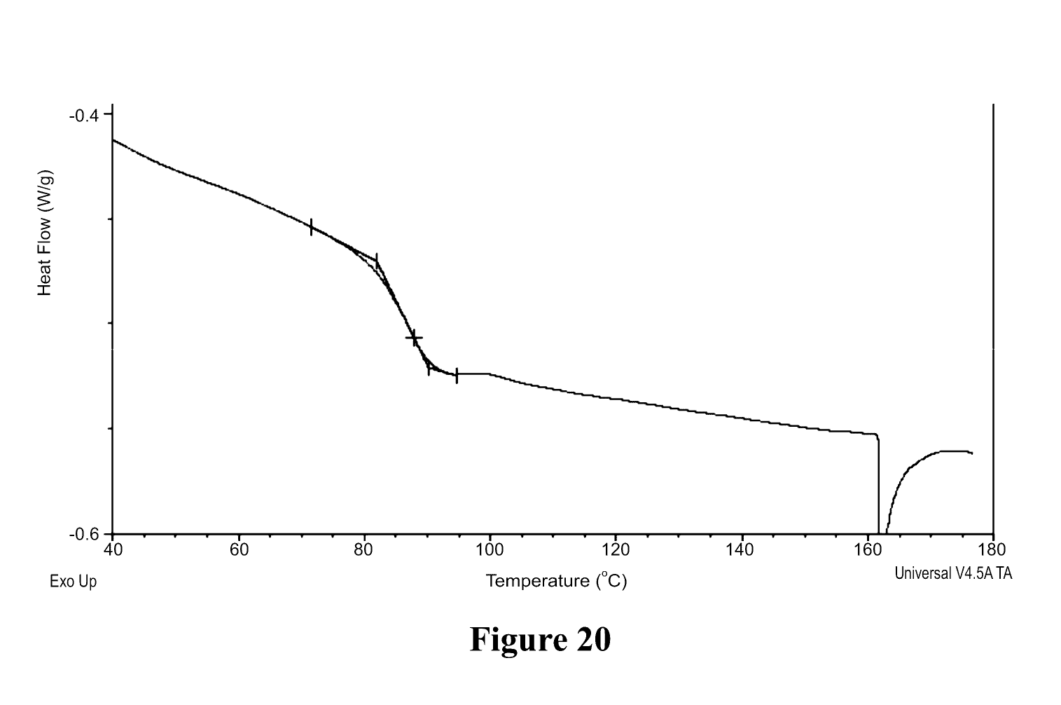

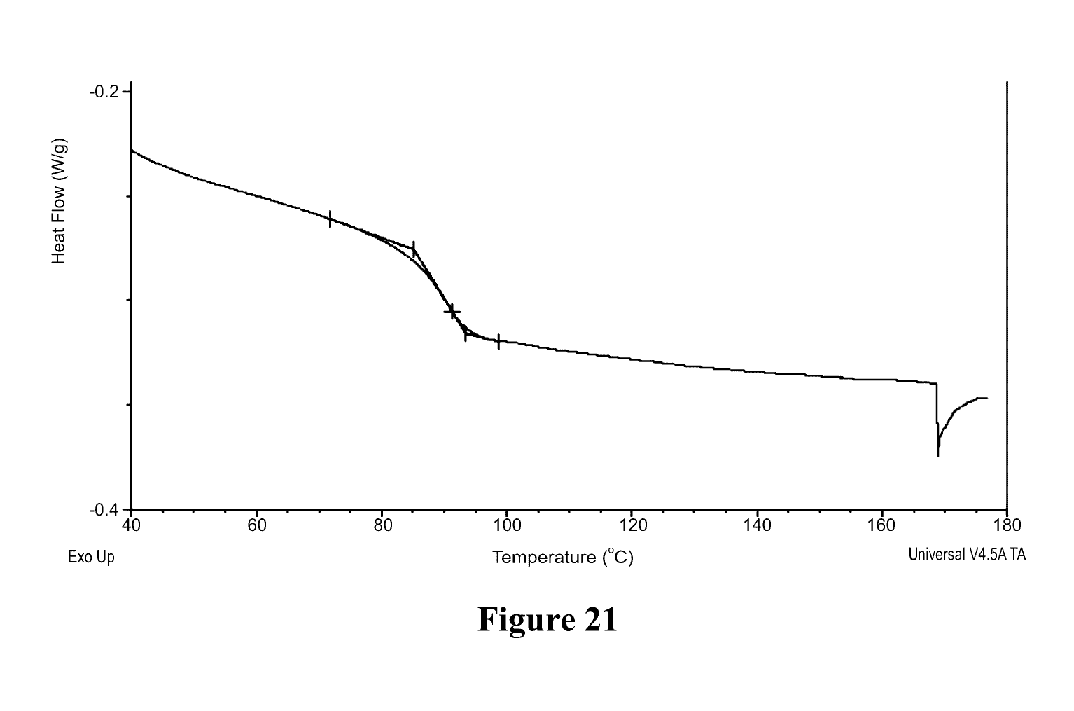

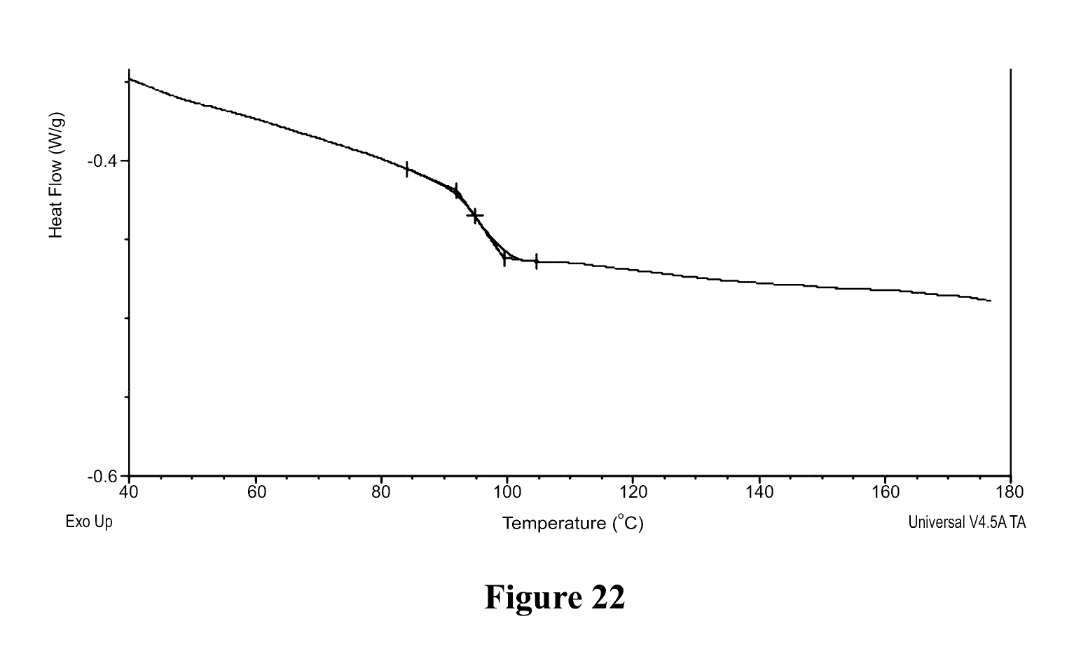

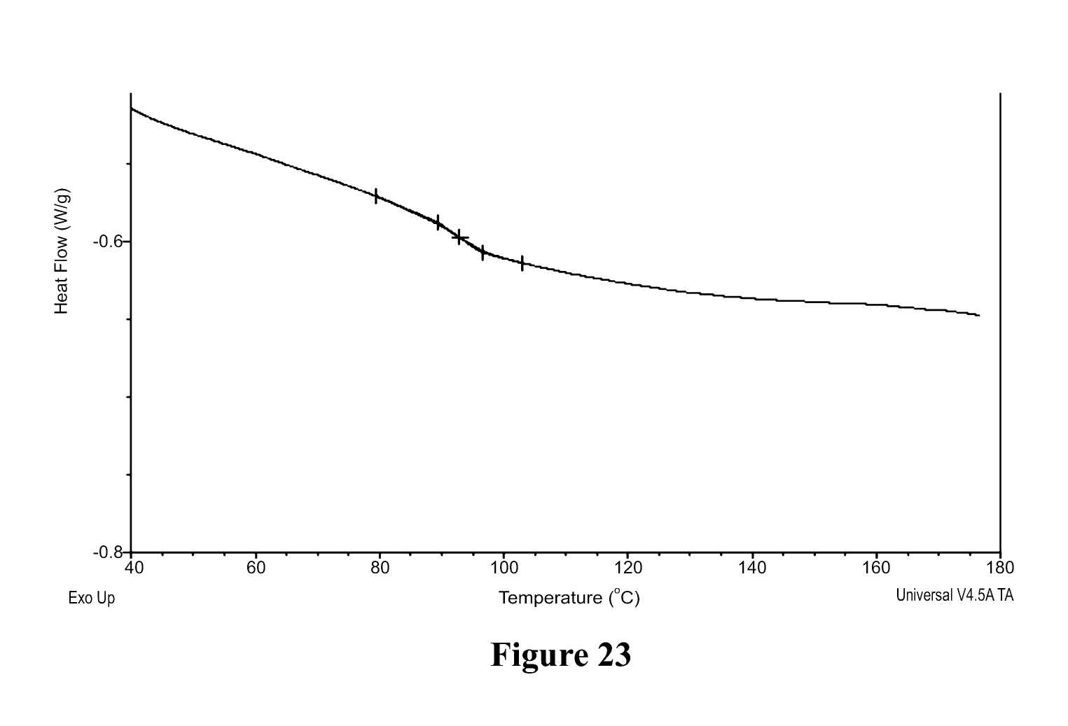

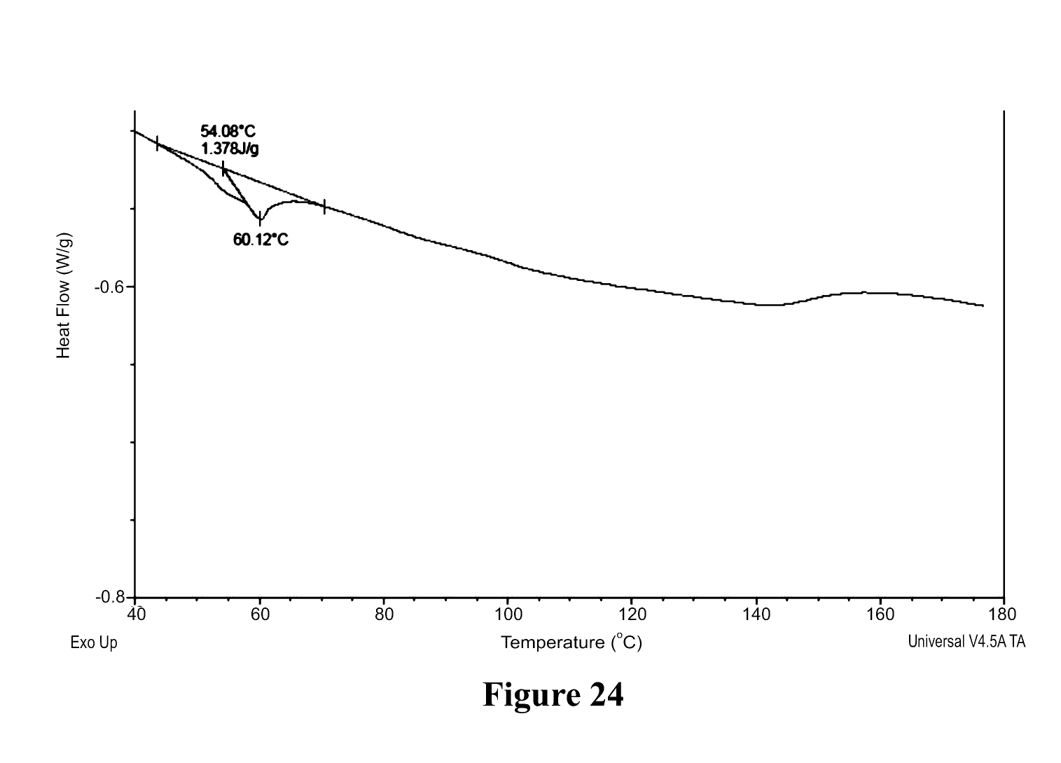

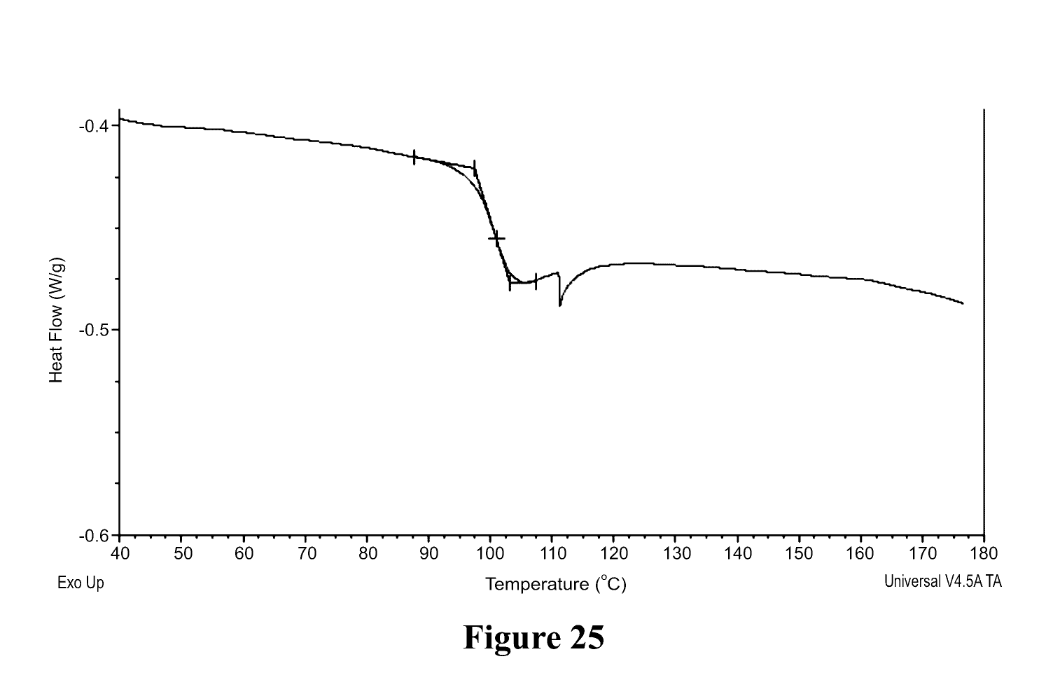

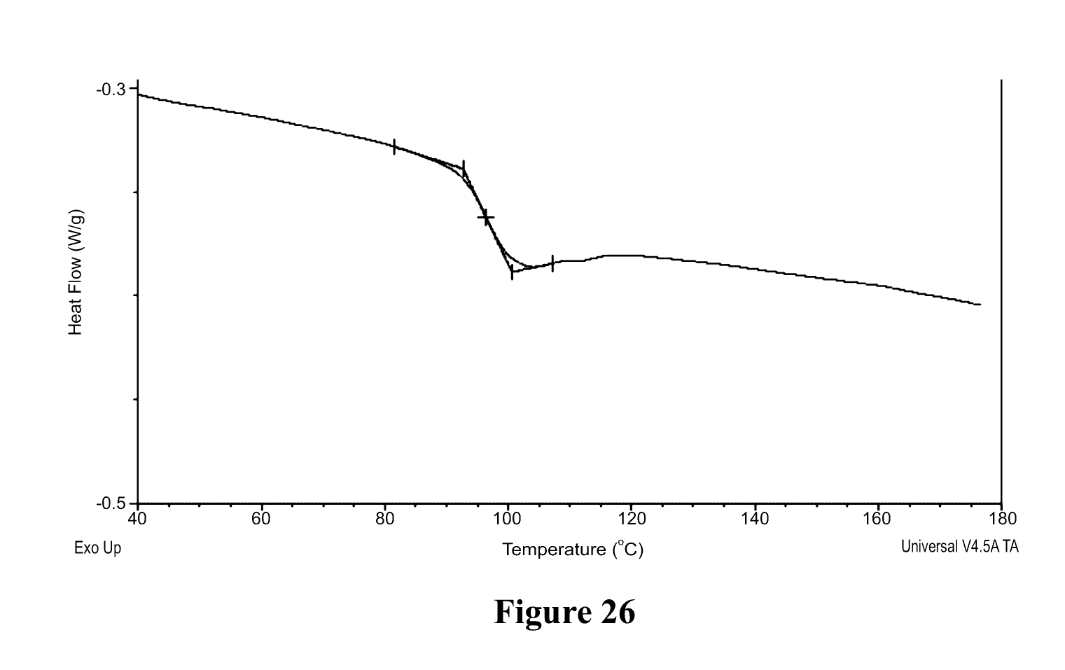

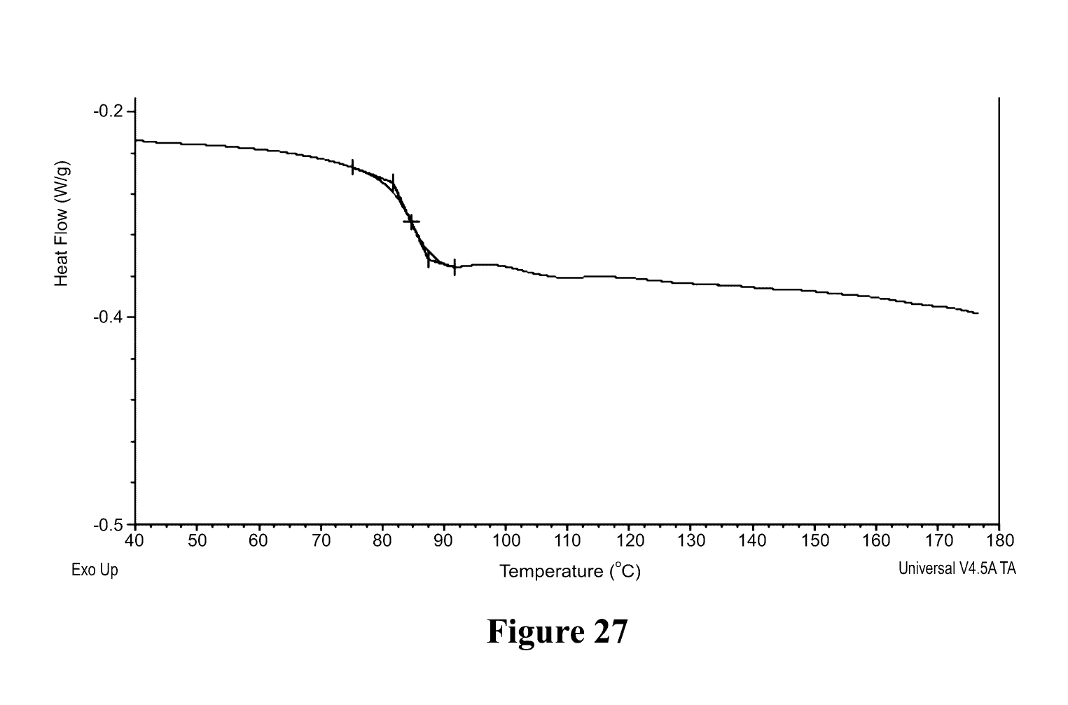

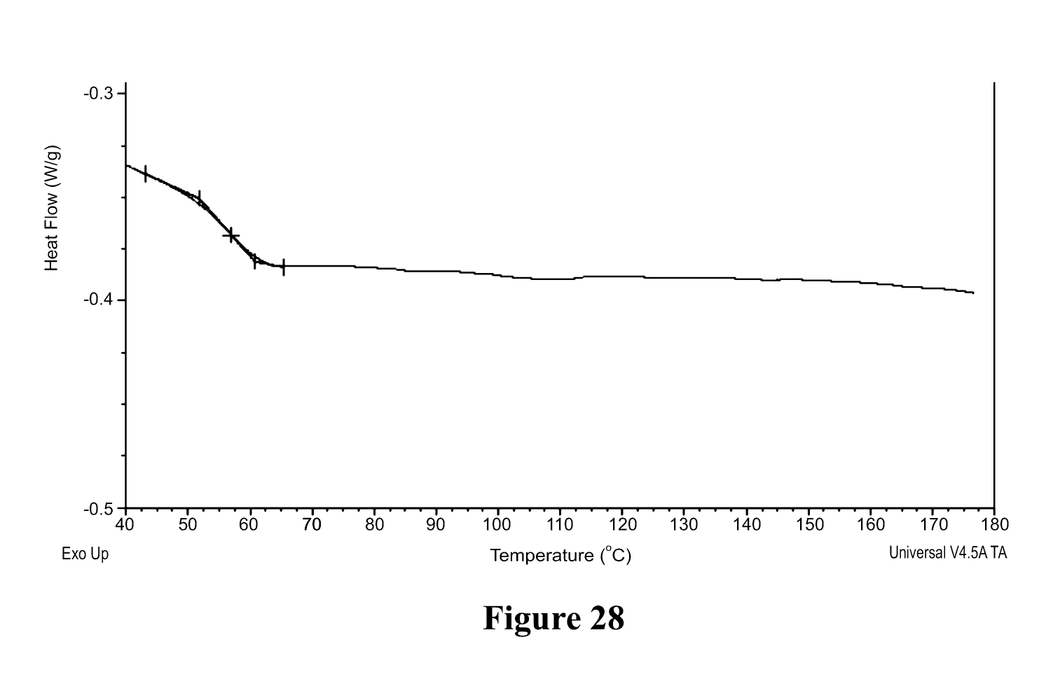

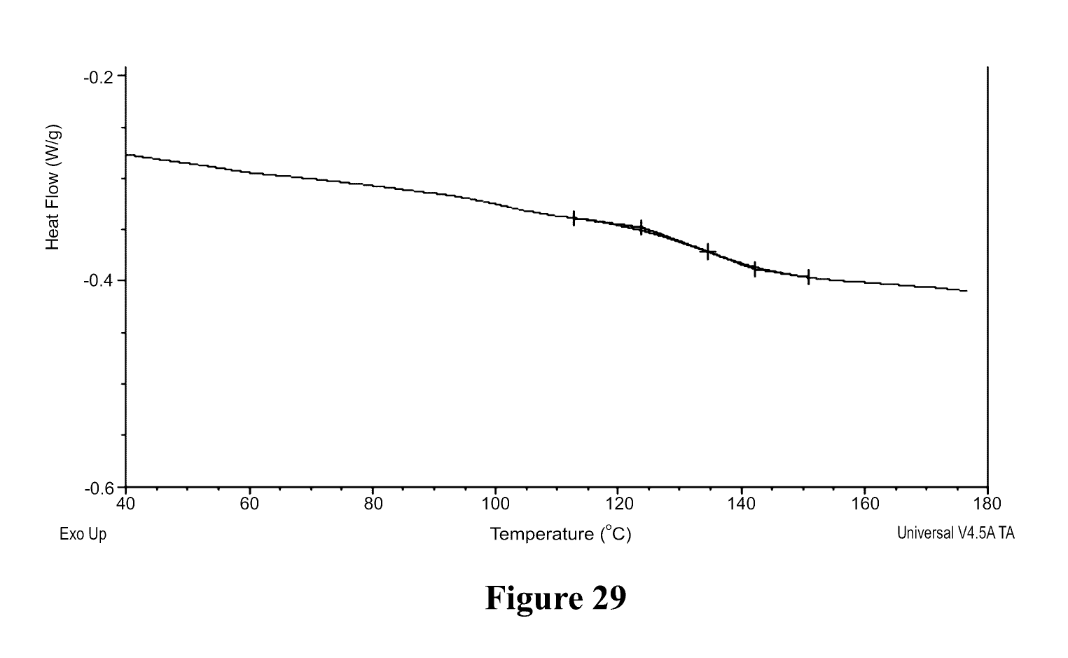

Thermal analysis was performed used TGA and DSC. Moisture contents of LS were measured by TGA and compared to those of BCL. As expected, BCL being more polar in character contained the highest amount of moisture. For non-polar materials, the moisture content was lowered with rising DS values. In addition to the moisture loss up to 100° C., residual mass was recorded upon completion of the TGA experiment. BCL when heated up to 600° C., yielded residual mass of 42.67%. This value was relatively high compared to LS. Since BCL is composed of mostly aromatic structures, it has relatively more thermal stability. Upon stearate substitution, significant mass contribution from the long aliphatic chains was observed. The stearate chain has a molar mass of 267 g/mol, while the lignin C₉ unit is 182 g/mol. Because the long aliphatic chains can thermally degrade relatively faster compared to the aromatic backbone of lignin, the residual masses obtained for LS are lower. To support this, we performed TGA analysis on stearic acid which yielded 0% residual mass. As shown in Table 2, for fully substituted LS-97%, the residual mass can be as low as 17%. Based on the knowledge of the stearate mass contributions in LS, expected residual masses were calculated for comparison with the TGA results. We assumed that 42.67% mass of the lignin fraction, and 0% mass of the stearate fraction remained after heating up to 600° C. The calculated residual mass values show good correlation with those from TGA, especially at high DS values. At low DS, a small difference in the calculated and experimentally measured residual mass values was observed. Nevertheless, it does point to the fact that the stearate chains thermally decompose faster compared to lignin. All TGA plots are provided in Supporting Information FIG. 8-FIG. 29.

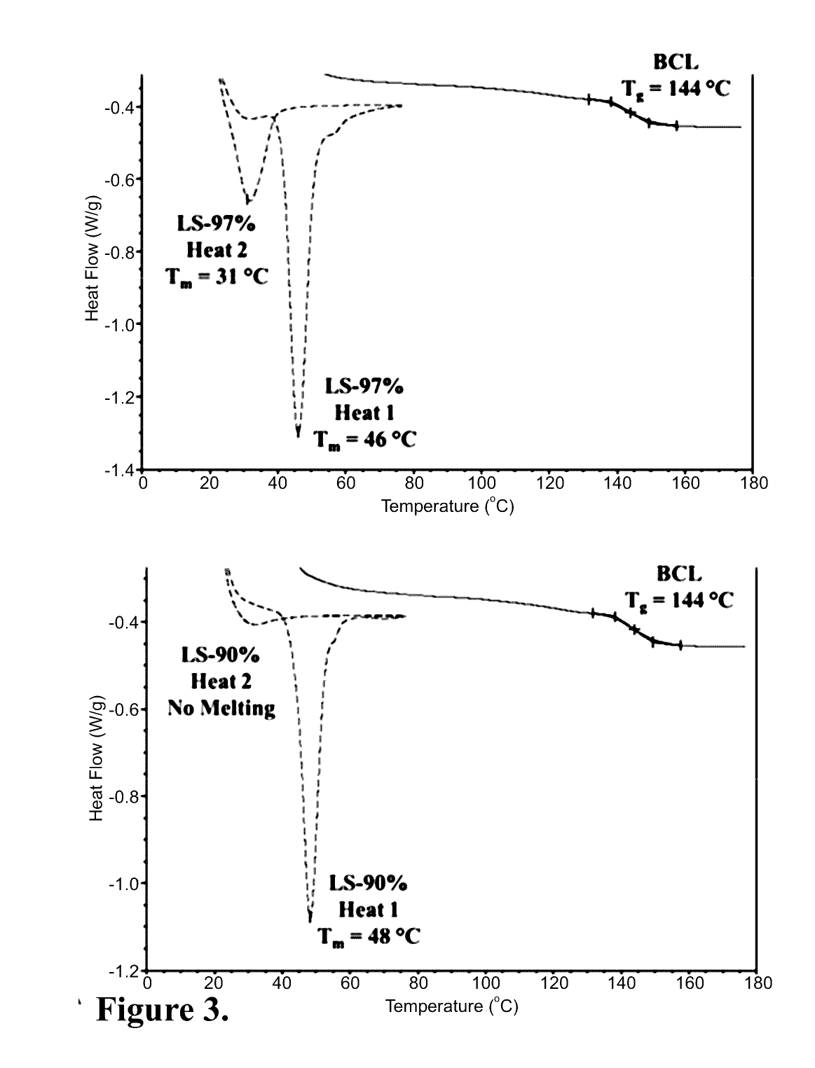

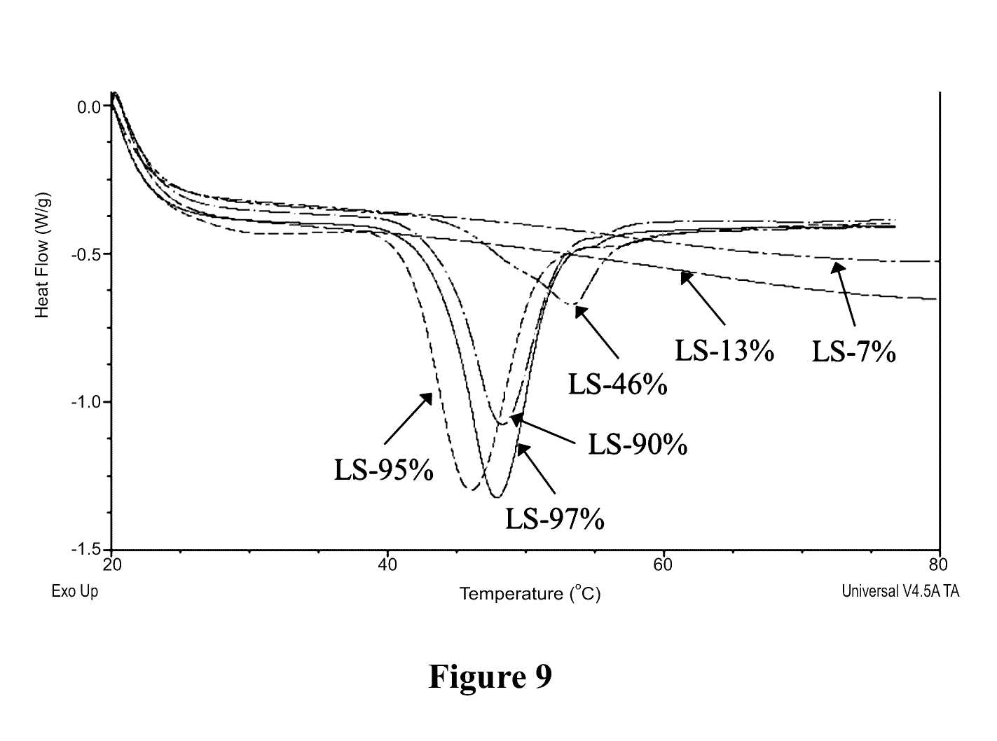

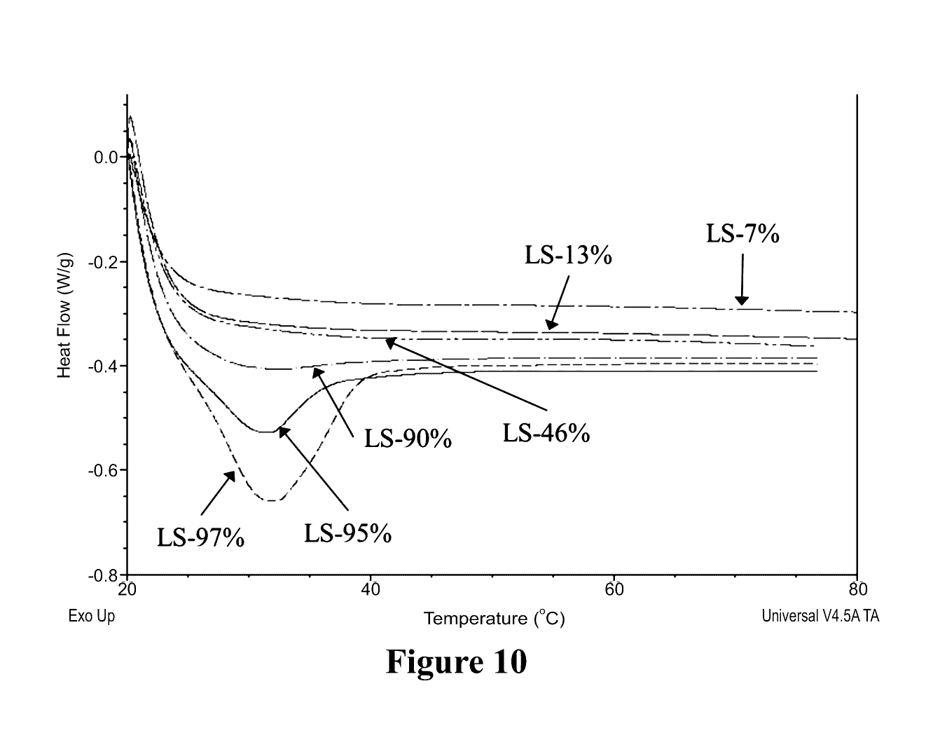

DSC analysis of BCL was performed according to a procedure that is typically used to measure the T_{g}'s of kraft lignin. In the 1^{st} scan, lignin was heated to 105° C. in order to remove moisture. Thereafter, in the 2^{nd} scan, lignin was heated up to 180° C. For BCL, the T_{g} appeared at 144° C., as shown in FIG. 3. When stearates were substituted on to lignin however, interesting behavior was observed. For LS-97% with heating and cooling rates of 10° C./min, a melting endotherm was observed in the 1st heating scan with Tₘ=46° C. In the 2^{nd} heating scan, the melting point was lowered to Tₘ=31° C. For LS-90% with heating and cooling rates of 10° C./min, a melting endotherm was observed in the 1^{st} heating scan with Tₘ=48° C. In the 2^{nd} heating scan however, no melting endotherm was observed. This type of behavior was intriguing, wherein at DS values nearing 100%, the melting process was reversible with endotherms observed in the 2^{nd} heating scans. At lower DS values (90% or lower), melting was irreversible wherein no endotherms were observed during the 2^{nd} heating scans. FIGS. 9 and 10 in Supporting Information shows comparisons of endotherms observed in the 1^{st} and 2^{nd} heating scans respectively, for all LS samples reported in Table 1. The melting points observed for all LS samples are reported in Table 4 of Supporting Information.

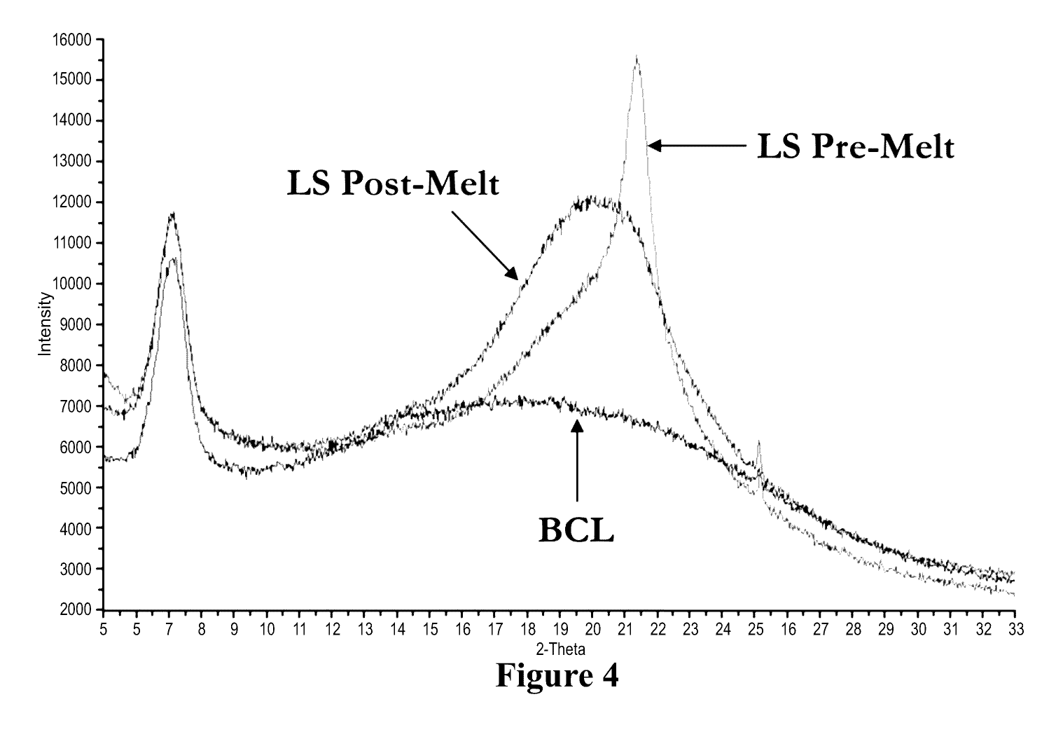

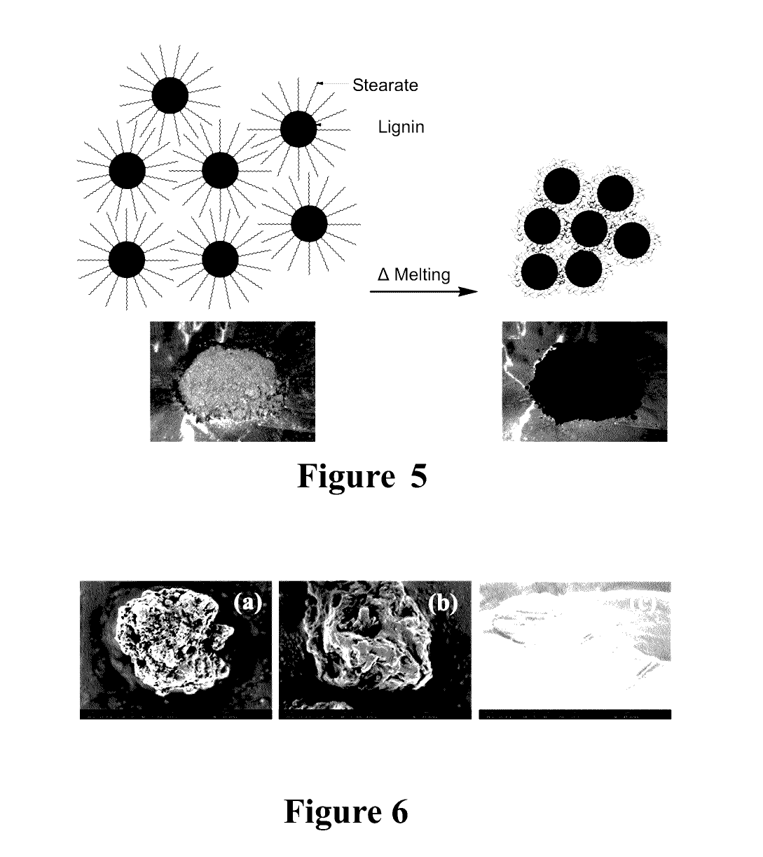

The behavior of LS wherein it melted in the 1^{st} heating scan, but did not melt in the 2^{nd} heating scan was probed further. Possible stearate crystallization was suspected to be occurring as LS was precipitated during reaction work up. These crystals likely melted upon heating. In order to confirm this, XRD measurements were performed on LS-90% prior to melting (LS Pre-melt) and after melting (LS Post-melt). The plots are shown in FIG. 4. BCL is amorphous, and as expected, and shows no crystalline peaks. LS Pre-melt however shows a clear crystalline peak appearing at 2θ≈22°. The same LS was then melted on a hot plate by heating upto 80° C. and allowed to cool back down to room temperature. The sample was then crushed and its XRD pattern was observed. Clearly, the crystalline peak disappears in LS Post-melt. This confirmed the suspicion that the stearate chains crystallize upon precipitation, but melt irreversibly. FIG. 5 shows a schematic representation of the melting of crystalline stearate chains, as well as images of lignin stearate pre- and post-melt. The peaks appearing at 2θ≈7° in XRD are from the X-ray window on the instrument.

SEM imaging was performed to study the morphology of the BCL compared to LS-90% pre-melt and post-melt. The data is shown in FIG. 6. Both BCL and LS Pre-melt were powders with fine particle size. Since sample preparation involved deposition on carbon tapes, these samples were easier to handle. LS Post-melt on the contrary was difficult to crush into a fine powder since it was sticky to handle. It was therefore crushed into fairly large sized chunks for imaging. Furthermore, during imaging, LS Post-melt showed stronger insulating behavior relative to BCL and LS Pre-melt. This presented a great challenge in acquiring decent images at higher magnification levels. We therefore used 10,000× magnification to compare the three samples. BCL particles were highly porous. When transformed into LS Pre-melt, the particles were relatively less porous. When melted and cooled back down to LS Post-melt, a very dense material was formed which showed no porosity. It is interesting to note that while LS Pre-melt and Post-melt are chemically alike, a single melt-cool cycle transforms its physical characteristics drastically from a porous, crystalline substance to a non-porous and amorphous one.

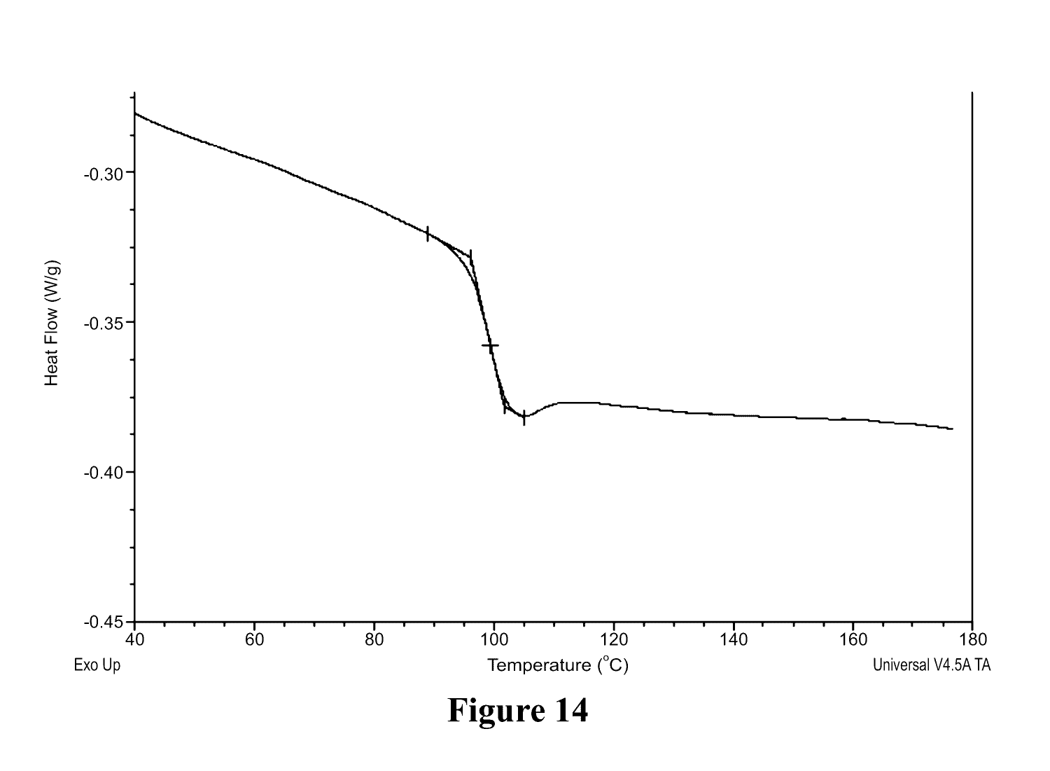

In order to study the applicability of LS in compatibilizing PS, its blends with BCL, LS-46% and LS-97% were prepared by solvent casting. DSC experiments were designed such that the films were heated up to 180° C. in the 1st heating scan before cooling back down to 20° C. The transitions occurring in the 2^{nd} heating scans were then studied. As mentioned previously, LS shows crystalline behavior when precipitated or dried from solvents. True blends were formed only when the films were heated in the 1^{st} scan above the softening temperatures of the respective components. Measuring the transitions in the 2^{nd} heat therefore allowed accurate T_{g} determinations. Additionally, the blended films were in intimate contact with the bottoms of the DSC pans during 2nd heat which prevented noise in the thermograms. The T_{g} and ΔCₚ values are reported in Table 3. All DSC thermograms are depicted in FIGS. 14-29 of Supporting Information.

PS film cast from an acetone solution showed a T_{g}=99° C. with an associated ΔCₚ=0.242 J/g/° C. For the concentrations ranges studied, 5% and 25% blends yielded integral films for BCL, LS-97% and LS-46%. At weight ratios of 50% and above, the films were brittle and did not show structural integrity. It is interesting to compare the thermal properties of all three lignin-PS mixtures at 25% concentration. For BCL, LS-46% and LS-97%, the T_{g} measured were 96, 91 and 78° C. respectively. The corresponding ΔCₚ values for BCL, LS-46% and LS-97%, which provide a measure of the softening ability were 0.231 (5% drop relative to pure PS), 0.193 (20% drop relative to pure PS) and 0.218 J/g/° C. (10% drop relative to pure PS). This proves that at 25% concentration, which was the highest concentration at which integral films were obtained, LS lowered the T_{g} significantly more compared to BCL. Furthermore, LS with high stearate substitution had a stronger plasticization effect relative to low substitution. In the case of PS-LS-97% blends, at LS concentration of 50% and above, melting endotherms originating from LS-97% persisted. This indicates that the lowering of the T_{g} of PS at high concentrations of LS-97% is not efficient, as is supported by a T_{g}=89° C. at 50% concentration, which is higher than the Tg=78 C for the LS-97% at 25% concentration. PS blends with LS-46% show similar behavior wherein there is a rise in T_{g} above 25% concentration of LS-46%.

Blends of PS with BCL (Tg=14×C) showed unexpected behavior with the lignin causing a depression in the Tg of the PS. This might be due to the lower molecular weight fractions of lignin being more miscible with the PS and thus acting as a plasticizer. However, at equal weight % additions to PS, the BCL showed smaller Tg depressions than did higher LS samples, reflecting a better miscibility of the LS material relative to the BCL. Blends of PS with BCL showed unexpected behavior. With increasing BCL concentrations up to 75%, the T_{g} values were reduced to as low as 57° C. This is very surprising because pure PS has a T_{g} close to 100° C., while pure BCL has a T_{g} close to 140° C. Even as miscible blends are formed, a lowering of T_{g} below 100° C. is unexpected. One possible explanation is that as the blends are formed by dissolution of PS+BCL in dioxane, a small amount of solvent is always retained which has a plasticization effect, yielding lower than expected T_{g} values.

Method of Making Unsaturated Fatty Acid Derivatives of Lignin without Solvent/Catalyst.

In order to develop windows of temperatures in which lignin based material is processable and does not crosslink significantly, unsaturated fatty acids were used to produce a flowable material with thermoplastic behavior. In this study, we analyze a commercially important softwood kraft lignin, which is expected to be difficult into spinning of fibers. The T_{g} of the lignin and the lignin mixed with various amounts of fatty acids and with different thermo-mechanical conditions mixing were determined using DSC. Some materials were processed using a twin screw extruder at either 130 or 160° C. for 5 seconds to 10 minutes of residence time at 120 rpm. Other samples at low fatty acid levels (<20% based on lignin) could not be mixed in the extruder, with the realized torque above the maximum for the extruder equipment (about 6000 Newtons). For these samples the unsaturated fatty acid which play a role as an internal or covalently-linked plasticizer was mixed manually at room temperature for 5 minutes then hot pressed between two metal disks at 130° C. and held for 15 minutes under 3000 psi and then cooled to room temperature.

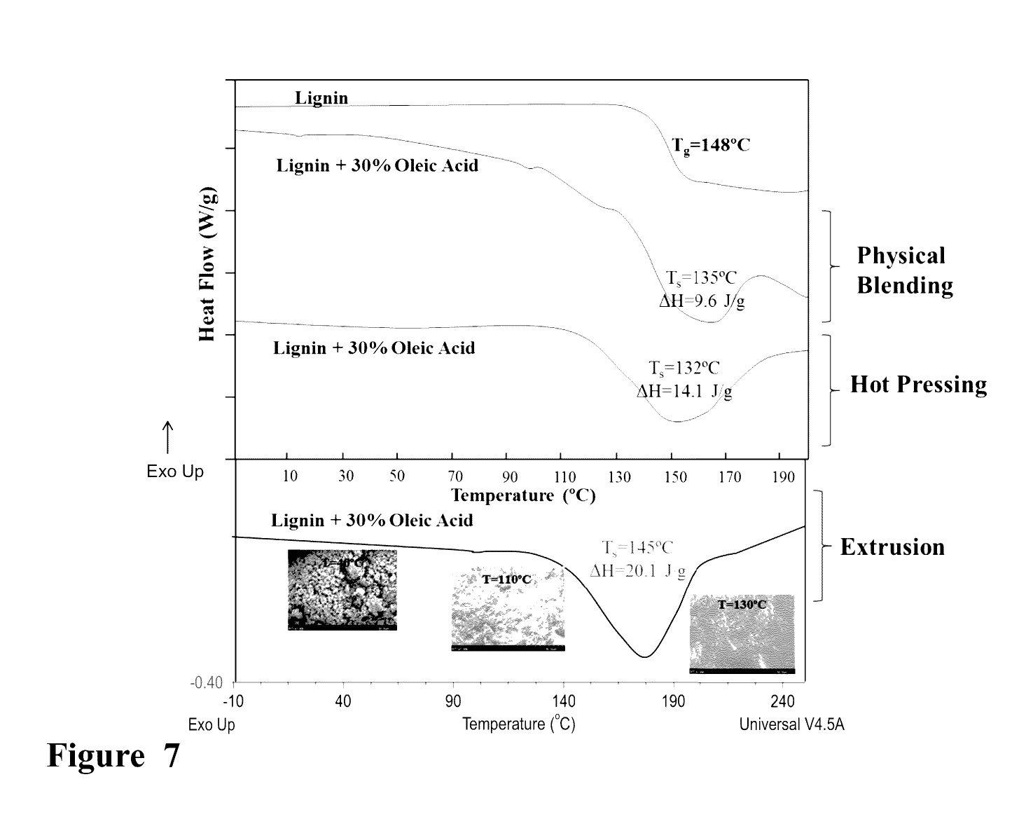

The reactor of twin screw extruder is a device designed for compounding and analyzing the rheological behavior of polymers on a 15 g-capacity DSM micro-extruder (Midi 2000 Heerlen, The Netherlands). It consists of a sealed body containing two co-rotating conical screws. The system is fed once by compacting the mix loaded in a compartment with a piston at the beginning of the cycle. The system temperature is regulated by electric resistors and air flow. Via an integrated back flow channel, the filled-in mix can be reintroduced in the system, upstream in a loop after a chosen reaction time. The measurement of the motor torque and pressure from the sensors in the loop channel allow the monitoring of the sample's rheological behavior. The results are shown in FIG. 7.

The change in heat capacity is known to decrease for crosslinking polymers with increased crosslinks due to decreased mobility in the liquid/rubbery state. Note that the ΔCₚ of the lignin materials processed at higher temperatures are lower than those processed at room temperature, in agreement with more crosslinks and higher molecular weight. Note that this difference is much more pronounced at low or zero levels of fatty acids. At higher levels of fatty acid this difference is smaller than at low levels of unsaturated fatty acids.

The T_{g} of the fatty acid derivatives of lignin decreases with increasing weight percent unsaturated fatty acids at a linear rate (R² values of 0.967) for 0-40% unsaturated fatty acids. Moreover, the T_{g} measured depends on the extruding temperature, with higher extruding temperature resulting in higher T_{g} of the mixture. These increases in T_{g} are reflective of the thermally induced reactions of lignin (primarily the phenolic hydroxyl groups) that cause increased molecular weight and crosslinking.

Methods of Spinning and Improving Workability and Yields

The spinnability of several the lignin-unsaturated fatty acid derivatives of lignin was carried out by twin screw extrusion through an orifice with a diameter of between 0.1 to 1 mm. Conditions were (between 5 seconds to 10 minutes, 120 RPM, range of temperature 130-160° C., 40% unsaturated fatty acid). The fatty acid derivatives of lignin at 40% flowed with a low viscosity and thus could not be spun into fibers, leaving the extruder as samples that formed irregular closed pore foamed materials. The lignin-unsaturated fatty acid derivatives had moderately high molecular weight and low torque values.

The lignin is expected to crosslink to other lignin molecules by radical reactions due to radical formation in phenol groups. The unsaturated fatty acids slows this process by diluting the reactive lignin and thus reducing the collisions of reactive groups. A significantly decreased rate of viscosity increases occurs at unsaturated fatty acid levels of over 20%. Note that at less than 20% unsaturated fatty acid, the material would not exit the extruder, showing thermosetting type behavior on the surface of the screws. Lignin molecular weights, as determined by GPC, post extrusion as well as extruder torque for pure kraft lignin and unsaturated fatty acids derivatives of lignin. Lignin molecular weights were measured after various extruder residence times for the 60-40 lignin fatty acids derivatives. A linear increase in lignin molecular weight up to 5 minutes (300 s) extruder residence time has been shown. This trend is interesting from a practical perspective because it suggests that extruder residence time can be used as a handle to control the final molecular weight of extruded fatty acid derivatives of lignin. However, additional processing or heat/shear exposure will likely cause additional crosslinking and molecular weight increases. This phenomenon is one of the major issues of why lignin is a challenging raw material to use for bio-based materials production.

As stated above, the melt spinning of softwood lignin is extremely difficult. The main desirable processing requirement of lignin is to be able to generate a stable softened or flowable lignin in a temperature window between the softening and decomposition/degradation temperatures. It was shown in the previous section that some unsaturated fatty acids reacted with the lignin sometimes do not result in material suitable for fiber production with good mechanical properties but played a good role as an internal or covalently-linked plasticizer. In this research we investigate some polymer blends and the effects of unsaturated fatty acid on the commercial softwood kraft lignin spinnability.

At a fatty acid derivative of lignin and polymer blend prepared by adding 5% of polymer based on lignin, the materials in the twin screw extruders caused the torque to increase rapidly in much less than 6 seconds. The materials were not softened during this process. However, by adding between 20% to 40% based on lignin and to the lower polymer blend levels (5% or less) the resulting material was easily extruded with low torque. The fatty acid enabled the continuous spinning of fine fibers with smooth surface for 5% or less polymer levels, much better than any of the polymer blends without fatty acid derivatives of lignin.

Thermostabilization and Carbonization

This study is a precursor to using softwood kraft lignin as precursors for fibers including carbonized fibers. The purpose of carbonization under these conditions (temperature and nitrogen atmosphere) is to produce glassy carbon layer planes with a high carbon content. Yields of material after pyrolysis (heating rate of 3.3° C./min from 40 to 700° C.) showed that after irradiation that the yield went up from 45% to 54%.

To carbonize and stabilize the samples were weighed in ceramic boats and slid into the tube furnace. The tube was then purged of oxygen by subjecting it to 3 L/min of N₂ gas for 10 minutes. The samples were heated from 40 to 700° C. at 3° C./min under a N₂ flow of 0.2 L/min. When the furnace reached 700° C., the furnace was shut off and opened, allowing the sample to cool. Nitrogen flow was cut off when the furnace had cooled to 200° C. The samples were allowed several hours to cool to room temperature and then weighed.

### 6.3. Conclusions

A strategy to attach fatty acid molecules to softwood kraft lignin using simple acylation chemistry was reported. Saturated C₁₈ fatty acids were attached to prepare lignin stearate, whereby the number of fatty acids attached can be controlled by varying the molar equivalents of reagent added. A new ¹H-NMR method was developed for quantification of the degree of substitution. Interesting physical properties were observed, wherein LS was found to melt at temperatures as low as 50° C. At very high % DS values (close to 100%), the melting phenomenon was reversible, but at low % DS, melting occurred only during the 1st heat. Melting originated from the crystallization of stearate chains when LS was purified by precipitation. When blends of PS with LS or with BCL at 25% concentration were compared, LS-97% was found to lower the T_{g} of PS from 100° C. to 78° C. whereas LS-46% lowered the T_{g} to 91° C., whereas and BCL lowered the T_{g} to 96° C., indicating better plasticization efficiency for the higher DS materials. At LS concentrations up to 25% integral blend films can be formed in which the T_{g} of PS can be lowered by up to 22° C. Lignin stearates may therefore serve as interesting candidates for further studies on their ability to plasticize not only PS but other thermoplastics as well.

### 6.4. Abbreviations

LS, Lignin stearate; DS, Degree of substitution; PS, Polystyrene; PE, Polyethylene; PP, Polypropylene; PVC, Polyvinyl Chloride; HPL, Hydroxypropyl lignin; PEG, Polyethylene glycol; St-Cl, Stearoyl chloride; Pyr, Pyridine; TGA, Thermogravimetric analysis; DSC, Differential scanning calorimetry; FTIR, Fourier transform infrared spectroscopy; ¹H-NMR, Proton nuclear magnetic resonance spectroscopy; XRD, X-ray diffraction; SEM, Scanning electron microscopy; TMS, Teteramethylsilane; PFB, 2,3,4,5,6-pentafluorobenzaldehyde.

### 7. REFERENCES

1. Crestini, C.; Melone, F.; Sette, M.; Saladino, R., Biomacromolecules 2011, 12 (11), 3928-3935.
2. Gosselink, R.; De Jong, E.; Guran, B.; Abächerli, A., Ind Crop Prod 2004, 20 (2), 121-129.
3. Vishtal, A.; Kraslawski, A., Bioresources 2011, 6 (3).
4. Sadeghifar, H.; Cui, C.; Argyropoulos, D. S., Ind Eng Chem Res 2012, 51 (51), 16713-16720.
5. Cui, C. Z.; Sadeghifar, H.; Sen, S.; Argyropoulos, D. S., Bioresources 2013, 8 (1), 864-886.
6. Wu, L. C. F.; Glasser, W. G., J Appl Polym Sci 1984, 29 (4), 1111-1123.
7. Glasser, W. G.; Barnett, C. A.; Rials, T. G.; Saraf, V. P., J Appl Polym Sci 1984, 29 (5), 1815-1830.
8. Kelley, S. S.; Glasser, W. G.; Ward, T. C., J Wood Chem Technol 1988, 8 (3), 341-359.
9. Saraf, V. P.; Glasser, W. G., J Appl Polym Sci 1984, 29 (5), 1831-1841.
10. Saraf, V. P.; Glasser, W. G.; Wilkes, G. L.; McGrath, J. E., J Appl Polym Sci 1985, 30 (5), 2207-2224.
11. Saraf, V. P.; Glasser, W. G.; Wilkes, G. L., J Appl Polym Sci 1985, 30 (9), 3809-3823.
12. Capanema, E. A.; Balakshin, M. Y.; Kadla, J. F., J Agr Food Chem 2004, 52 (7), 1850-1860.
13. Ayoub, A.; Venditti, R. A.; Jameel, H.; Chang, H.-M., J Appl Polym Sci 2014, 131 (1), 39743.
14. Pietarinen, S.; Myllymäki, T.; Eskelinen, K. A method for esterifying lignin with at least one fatty acid. WO2014029919 A1, 2014.
15. Pawar, S. N.; Edgar, K. J., Biomacromolecules 2011, 12 (11), 4095-4103.

Tables

TABLE 1
Amounts of reagents in reaction, corresponding
DS and product solubilities

| | St-Cl eq. | Pyr eq. | DS per 100 | | | | | | |
|---|---|---|---|---|---|---|---|---|---|
| LS | added | added | aromatic | % | Solubility | | | | |
| sample | per OH | per OH | rings | DS | A | B | C | D | E |
| LS-7% | 0.30 | 0 | 6.09 | 7 | N | N | Y | Y | N |
| LS-13% | 0.59 | 0 | 12.29 | 13 | N | N | Y | Y | N |
| LS-46% | 1.18 | 0 | 43.43 | 46 | Y | Y | N | N | N |
| LS-90% | 2.36 | 0 | 84.40 | 90 | Y | Y | N | N | N |
| LS-95% | 2.36 | 0.12 | 89.28 | 95 | Y | Y | N | N | N |
| LS-97% | 2.36 | 0.50 | 90.72 | 97 | Y | Y | N | N | N |

Soluble - Y;
Insoluble - N A - Hexane;
B - Chloroform;
C - Ethanol;
D - DMSO;
E - Water

TABLE 2
Total moisture content and mass loss
measured using TGA and gravimetry

| | |
|---|---|
| Moisture Content | Residual Mass (%) |

| Sample | by TGA (%) | By TGA | By Calculation |
|---|---|---|---|
| BCL | 2.32 | 42.67 | — |
| LS-7% | 1.94 | 46.18 | 38.93 |
| LS-13% | 0.94 | 39.38 | 36.20 |
| LS-46% | 0.66 | 28.24 | 26.13 |
| LS-90% | 0.0 | 21.04 | 19.04 |
| LS-95% | 0.0 | 16.82 | 18.46 |
| LS-97% | 0.0 | 17.50 | 18.25 |

Residual mass by calculation was determined using the mass fractions of fatty acid chains relative to the mass of lignin. Residual mass of the fatty acid chains was assumed to be 0%, whereas that of lignin was assumed to be 42.67% (as obtained via TGA analysis of pure lignin)

TABLE 3
T_{g} and ΔCₚ values for PS blends with BCL, LS-46%
and LS-97% measure by DSC in the 2^{nd} heating scan

| | | | T_{g} | ΔCₚ | MP |
|---|---|---|---|---|---|
| | | | (° C.) | (J/g/° C.) | (° C.) |
| PS | | | 99 | 0.242 | — |
| | BCL | | Xxxx | xxxxx | |
| | LS-97% content | 5% | 98 | 0.237 | — |
| | in PS | 25% | 78 | 0.218 | — |
| | | 50% | 89 | 0.236 | 52 |
| | | 75% | — | — | 54 |
| | | 100% | — | — | 54 |
| | LS-46% content | 5% | 88 | 0.252 | — |
| | in PS | 25% | 91 | 0.193 | — |
| | | 50% | 95 | 0.209 | — |
| | | 75% | 93 | 0.102 | — |
| | | 100% | — | — | 60 |
| | BCL content | 5% | 101 | 0.277 | — |
| | in PS | 25% | 96 | 0.231 | — |

TABLE 4
Melting points observed in the 1^{st} and 2^{nd} heating
scans in DSC for LS samples reported in Table 1

| | Heat 1 Tₘ₁ | Heat 2 Tₘ₂ |
|---|---|---|
| | (° C.) | (° C.) |
| LS-97% | 46 | 32 |
| LS-95% | 48 | 31 |
| LS-90% | 48 | — |
| LS-46% | 53 | — |
| LS-13% | TBA | TBA |
| LS-7% | — | — |

TABLE 5
Residual masses by TGA for PS blends
with LS-97%, LS-46% and BCL

| | | | Residual mass (%) by TGA |
|---|---|---|---|
| PS | | | 0.16 |
| | PS + | 5% | 2.49 |
| | LS-97% | 25% | 2.08 |
| | | 50% | 4.84 |
| | | 75% | 16.90 |
| | | 100% | 16.62 |
| | PS + | 5% | 1.58 |
| | LS-46% | 25% | 5.08 |
| | | 50% | 5.70 |
| | | 75% | 13.43 |
| | | 100% | 29.38 |
| | PS + | 5% | 1.51 |
| | BCL | 25% | 5.12 |
| | | 50% | 5.04 |
| | | 75% | 5.75 |
| | | 100% | 36.09 |

TABLE 6
Common Fatty Acids and Sources

| Common | | Double | | |
|---|---|---|---|---|
| Name | C | bonds | Scientific Name | Sources |
| Butyric acid | 4 | 0 | butanoic acid | butterfat |
| Caproic Acid | 6 | 0 | hexanoic acid | butterfat |
| Caprylic Acid | 8 | 0 | octanoic acid | coconut oil |
| Capric Acid | 10 | 0 | decanoic acid | coconut oil |
| Lauric Acid | 12 | 0 | dodecanoic acid | coconut oil |
| Myristic Acid | 14 | 0 | tetradecanoic acid | palm kernel |
| | | | | oil |
| Palmitic Acid | 16 | 0 | hexadecanoic acid | palm oil |
| Palmitoleic | 16 | 1 | 9-hexadecenoic acid | animal fats |
| Acid | | | | |
| Stearic Acid | 18 | 0 | octadecanoic acid | animal fats |
| Oleic Acid | 18 | 1 | 9-octadecenoic acid | olive oil |
| Ricinoleic acid | 18 | 1 | 12-hydroxy-9- | castor oil |
| | | | octadecenoic acid | |
| Vaccenic Acid | 18 | 1 | 11-octadecenoic acid | butterfat |
| Linoleic Acid | 18 | 2 | 9,12-octadeca- | grape seed |
| | | | dienoic acid | oil |
| Alpha-Linolenic | 18 | 3 | 9,12,15-octadeca- | Flaxseed |
| Acid (ALA) | | | trienoic acid | (linseed) oil |
| Gamma- | 18 | 3 | 6,9,12-octadeca- | Borage oil |
| Linolenic Acid | | | trienoic acid | |
| (GLA) | | | | |
| Arachidic Acid | 20 | 0 | eicosanoic acid | Peanutoil, |
| | | | | fish oil |
| Gadoleic Acid | 20 | 1 | 9-eicosenoic acid | fish oil |
| Arachidonic | 200 | 4 | 5,8,11,14- | liver fats |
| Acid (AA) | | | eicosatetraenoic acid | |
| EPA | 20 | 5 | 5,8,11,14,17- | Fish oil |
| | | | eicosapentaenoic acid | |
| Behenic acid | 22 | 0 | docosanoic acid | rapeseed oil |
| Erucic acid | 22 | 1 | 13-docosenoic acid | rapeseed oil |
| DHA | 22 | 6 | 4,7,10,13,16,19- | |
| | | | docosahexaenoic | |

It should be understood that the above description is only representative of illustrative embodiments and examples. For the convenience of the reader, the above description has focused on a limited number of representative examples of all possible embodiments, examples that teach the principles of the disclosure. The description has not attempted to exhaustively enumerate all possible variations or even combinations of those variations described. That alternate embodiments may not have been presented for a specific portion of the disclosure, or that further undescribed alternate embodiments may be available for a portion, is not to be considered a disclaimer of those alternate embodiments. One of ordinary skill will appreciate that many of those undescribed embodiments, involve differences in technology and materials rather than differences in the application of the principles of the disclosure. Accordingly, the disclosure is not intended to be limited to less than the scope set forth in the following claims and equivalents.

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not be taken as an acknowledgment or any form of suggestion that they constitute valid prior art or form part of the common general knowledge in any country in the world. It is to be understood that, while the disclosure has been described in conjunction with the detailed description, thereof, the foregoing description is intended to illustrate and not limit the scope. Other aspects, advantages, and modifications are within the scope of the claims set forth below. All publications, patents, and patent applications cited in this specification are herein incorporated by reference as if each individual publication or patent application were specifically and individually indicated to be incorporated by reference.

What is claimed is:

1. A fatty acid derivative of lignin consisting essentially of a lignin and a fatty acid.

2. The fatty acid derivative of claim 1, wherein the fatty acid and the lignin are present in a mole ratio ranging from about 0.1:1.0 to about 4.0:1.0.

3. The fatty acid derivative of claim 1, wherein the fatty acid ester derivative is soluble in a non-polar solvent.

4. The fatty acid derivative of claim 1, wherein the fatty acid ester derivative is soluble in a polar aprotic solvent.

5. The fatty acid derivative of claim 1, wherein the fatty acid ester derivative is soluble in a polar protic solvent.

6. The fatty acid derivative of claim 1, wherein the fatty acid is an unsaturated fatty acid.

7. The fatty acid derivative of claim 1, wherein the fatty acid is a saturated fatty acid.

8. The fatty acid ester derivative of claim 1, wherein the fatty acid ester is a C4-C30 ester.

9. The fatty acid derivative of claim 8, wherein the C4-C30 ester is a C18 fatty acid ester, a linoleic acid ester, or an oleic acid ester.

10. The fatty acid derivative of claim 1, wherein the lignin and the fatty acid are present in a ratio of about 1.0 lignin to about 0.1-0.6 fatty acid.

11. The fatty acid derivative of claim 1, wherein the lignin and the fatty acid are present in a ratio of about 1.0 lignin to about 0.2-0.5 fatty acid.

12. The fatty acid derivative of claim 1, wherein the lignin and the fatty acid are present in a ratio of about 1.0 lignin to about 0.2 to 0.4 fatty acid.

13. The fatty acid derivative of claim 1, wherein the lignin and the fatty acid are present in a ratio of about 1.0 lignin to about 0.3 to 0.4 fatty acid.

14. The fatty acid derivative of claim 1, wherein the fatty acid is a fatty acid of phosphatidylethanolamine, a fatty acid of soybean lecithin, or an unsaturated fatty acid of egg lecithin.

15. The fatty acid derivative of claim 1, wherein the lignin is a hardwood lignin.

16. The fatty acid derivative of claim 1, wherein the lignin is a softwood lignin.

17. The fatty acid derivative of claim 1, wherein the lignin is from a non-wood plant material.

18. The fatty acid derivative of claim 17, wherein the non-wood plant material is an energy crop agricultural waste, a food crop agricultural waste or a grass.

19. The article of manufacture of claim 19, wherein the thermoplastic polymer is a natural or synthetic polymer.

20-29. (canceled)

30. A method of improving the workability of a lignin which comprises esterifying the lignin with an activated fatty acid under suitable conditions so as to form a fatty acid derivative of lignin consisting essentially of the lignin and the fatty acid.

31-47. (canceled)
